(19) United States
(12) Patent Application Publication
(10) Pub. No.: US 2026/0091351 A1
(43) Pub. Date: Apr. 2, 2026

(54) SYSTEMS AND METHODS FOR CO2 CAPTURE USING MOLTEN SALTS

(71) Applicant: Mantel Capture, Inc., Cambridge, MA (US)

(72) Inventors: Cameron Halliday, Boston, MA (US); Sean Robertson, Cambridge, MA (US)

(21) Appl. No.: 19/211,956

(22) Filed: May 19, 2025

Related U.S. Application Data
(63) Continuation of application No. PCT/US2023/080613, filed on Nov. 20, 2023.
(60) Provisional application No. 63/384,582, filed on Nov. 21, 2022.

(51) Int. Cl. B01D 53/62; B01D 53/78; B01D 53/96

(52) U.S. Cl. CPC B01D 53/62; B01D 53/78; B01D 53/96; B01D 2252/10; B01D 2252/40; B01D 2257/504; B01D 2258/0283

(57) ABSTRACT

The present disclosure provides systems and methods for capturing carbon dioxide using molten salts. Streams comprising carbon dioxide from an industrial may be contacted with a molten borate salt to produce carbon rich streams. The carbon rich streams may be directed to a desorber where the molten salt is regenerated and pure carbon dioxide is released and used elsewhere.

### CROSS-REFERENCE TO RELATED APPLICATIONS

This application is a continuation application of International Patent Application No. PCT/US2023/080613, filed Nov. 20, 2023, which claims the benefit of U.S. Provisional Application No. 63/384,582, filed Nov. 21, 2022, each of which is incorporated herein by reference in its entirety.

### BACKGROUND

Industrial processes may generate carbon-containing products, such as CO₂. CO₂ is a greenhouse gas that may affect a change in the temperature of the Earth and contribute to global warming. Such industrial processes may include coal, oil, or fossil-fuel fired power plants, manufacturing processes, oil refineries, or any other process that produces carbon-containing products, either intentionally or as an unwanted by-product. Traditionally, CO₂ has been released into the environment or processed using an inefficient and resource intensive scrubber.

### SUMMARY

Systems and methods of capturing and releasing carbon dioxide using molten salts is disclosed herein. Such processes may minimize, for instance, carbon emissions from industrial processes. It is advantageous to utilize heat generated within the system to regenerate the molten salts and release carbon dioxide. However, certain methods include using steam as a sweep gas to regenerate molten salt in the desorber. There are practical challenges associated with passing high volumes of superheated steam through a desorber and other sections of a system (e.g., require re-design of the steam turbine) to recover carbon dioxide from the steam. Other methods include combusting fuel in high purity oxygen to achieve temperatures and heat required by the desorber to regenerate the molten salts. Such methods are inefficient and costly. Further, certain methods include using electrolysis to regenerate molten salts, however, such methods require large and prohibitive amounts of electrical energy. Accordingly, recognized herein is a need to address the aforementioned problems. Provided herein are systems and methods that utilize heat generated within a high temperature system to absorb and desorb carbon dioxide from molten salts, thereby minimizing external energy or heat input, costs associated thereof, and negative impacts on climate and environment, while increasing efficiency.

In one aspect, described herein is a method for capturing carbon dioxide (CO₂) from an industrial process, comprising: (a) providing a gaseous stream comprising CO₂; (b) contacting the gaseous stream with a first stream comprising a molten salt at an absorber, thereby absorbing CO₂ from the gaseous stream into the first stream to produce a second stream comprising the molten salt and the absorbed CO₂; (c) directing the second stream to a desorber; and (d) using the desorber, desorbing the absorbed CO₂ from the second stream, thereby generating (i) a third stream comprising the molten salt and (ii) an export stream comprising CO₂ desorbed from the second stream, wherein the third stream comprises less than 50 mol % steam.

In some embodiments, at least a portion of the industrial process occurs in a kiln. In some embodiments, at least a portion of the industrial process occurs in a reactor. In some embodiments, at least a portion of the industrial process occurs in a furnace.

In some embodiments, a temperature of at least a portion of the industrial process exceeds a temperature of 600° C. In some embodiments, a temperature of at least a portion of the industrial process exceeds a temperature of 1200° C. In some embodiments, a temperature of at least a portion of the industrial process exceeds a temperature of 2000° C.

In some embodiments, at least a portion of the industrial process comprises a combustion process. In some embodiments, at least a portion of the industrial process comprises a gasification process. In some embodiments, at least a portion of the industrial process comprises a reforming process. In some embodiments, at least a portion of the industrial process comprises a calcination process. In some embodiments, at least a portion of the industrial process comprises a smelting process. In some embodiments, at least a portion of the industrial process comprises burning a solid fuel. In some embodiments, the solid fuel comprises coal, biomass, waste, or refuse, or any combination thereof. In some embodiments, at least a portion of the industrial process comprises burning a gaseous fuel. In some embodiments, the gaseous fuel comprises natural gas, methane, propane, or refinery gas, or any combination thereof.

In some embodiments, at least a portion of the industrial process comprises generating electricity, steam, heat, cement, steel, hydrogen, pulp, or paper, or any combination thereof.

In some embodiments, at least a portion of the industrial process occurs in a boiler. In some embodiments, the boiler comprises a radiant section and a convection section.

In some embodiments, the radiant section exceeds a temperature of 600° C. In some embodiments, the radiant section exceeds a temperature of 1200° C. In some embodiments, the radiant section exceeds a temperature of 2000° C.

In some embodiments, the convection section exceeds a temperature of 200° C. In some embodiments, the convection section exceeds a temperature of 400° C. In some embodiments, the convection section exceeds a temperature of 600° C.

In some embodiments, the desorber is at a higher temperature than the absorber.

In some embodiments, the absorber is located in the convection section, and wherein the desorber is located in the radiant section.

In some embodiments, the absorber exceeds a temperature of 400° C. In some embodiments, the absorber exceeds a temperature of 500° C. In some embodiments, the absorber exceeds a temperature of 600° C. In some embodiments, the absorber exceeds a temperature of 700° C.

In some embodiments, the desorber exceeds a temperature of 700° C. In some embodiments, the desorber exceeds a temperature of 800° C. In some embodiments, the desorber exceeds a temperature of 900° C. In some embodiments, the desorber exceeds a temperature of 1000° C.

In some embodiments, the first stream comprises at least 0.01 moles of CO₂ per kilogram of molten salt. In some embodiments, the first stream comprises at least 0.1 moles of CO₂ per kilogram of molten salt. In some embodiments, the first stream comprises at least 1 mole of CO₂ per kilogram of molten salt. In some embodiments, the second stream comprises at least 1 mole of CO₂ per kilogram of molten salt. In some embodiments, the second stream comprises at least 10 moles of CO₂ per kilogram of molten salt. In some embodiments, the second stream comprises at least 100 moles of CO₂ per kilogram of molten salt.

In some embodiments, the export stream has a CO₂ concentration of greater than 80%. In some embodiments, the export stream has a CO₂ concentration of greater than 90%. In some embodiments, the export stream has a CO₂ concentration of greater than 95%. In some embodiments, the export stream has a CO₂ concentration of greater than 99%. In some embodiments, the export stream has a CO₂ concentration of greater than 99.9%.

In some embodiments, the desorber comprises a packed bed, tank, heat exchanger, or a combination thereof.

In some embodiments, wherein the desorber comprises packing material. In some embodiments, the packing material comprises random packing. In some embodiments, the packing material comprises structured packing.

In some embodiments, the method further comprises, prior to (c), directing the second stream to a heat exchanger.

In some embodiments, the method further comprises directing the third stream to the heat exchanger.

In some embodiments, the heat exchanger facilitates heat transfer from the third stream to the second stream.

In some embodiments, the heat exchanger comprises a shell and tube heat exchanger comprising a shell-side and a tube-side.

In some embodiments, the third stream is directed to the tube-side of the heat exchanger, and wherein the second stream is directed to the shell-side of the heat exchanger.

In some embodiments, the first stream and the third stream are the same.

In some embodiments, the first stream comprises at least a portion of the third stream.

In some embodiments, the heat exchanger is a salt-salt heat exchanger.

In some embodiments, the heat exchanger comprises a helical coil heat exchanger.

In some embodiments, the heat exchanger comprises a tube-in-tube heat exchanger.

In some embodiments, the tube-in-tube heat exchanger is a salt-salt heat exchanger.

In some embodiments, the second stream flows up an inner tube of the tube-in-tube heat exchanger and the third stream flows down an outer tube of the tube-in-tube heat exchanger.

In some embodiments, the heat exchanger comprises a printed circuit heat exchanger.

In some embodiments, the heat exchanger is located below the desorber.

In some embodiments, the heat exchanger is located at least 0.1 meters below the desorber. In some embodiments, the heat exchanger is located at least 1 meter below the desorber. In some embodiments, the heat exchanger is located at least 10 meters below the desorber.

In some embodiments, the method further comprises directing the third stream through a transfer pump.

In some embodiments, the transfer pump operates with an outlet pressure of at least 1 bar absolute. In some embodiments, the transfer pump operates with an outlet pressure of at least 5 bar absolute. In some embodiments, the transfer pump operates with an outlet pressure of at least 10 bar absolute. In some embodiments, the transfer pump operates with an outlet pressure of at least 20 bar absolute. In some embodiments, the transfer pump operates with an outlet pressure of at least 100 bar absolute.

In some embodiments, the method further comprises directing the third stream through one or more filters.

In some embodiments, the method further comprises directing the second stream through one or more filters.

In some embodiments, the first stream, second stream, or third stream comprises a molten borate.

In some embodiments, the molten borate has a chemical form of AₓB₁₋ₓO_{1.5-x}, wherein x is a number between 0 and 1, and wherein A comprises an alkali metal. In some embodiments, x is a number between about 0.5 and about 0.95. In some embodiments, A is Lithium (Li). In some embodiments, A is Sodium (Na). In some embodiments, A is Potassium (K). In some embodiments, A is Rubidium (Rb). In some embodiments, A is Caesium (Cs). In some embodiments, A is Francium (Fr). In some embodiments, A comprises Sodium and Lithium.

In some embodiments, the desorber is connected to the industrial process.

In some embodiments, carbon dioxide is generated as a by-product of at least a portion of the industrial process.

In some embodiments, the third stream comprises less than 20 mol % steam. In some embodiments, the third stream comprises less than 10 mol % steam. In some embodiments, the third stream comprises less than 5 mol % steam.

In some embodiments, the third stream has no detectable steam.

In some embodiments, the gaseous stream comprising CO₂ is generated from the industrial process.

In another aspect, described herein is a method for retrofitting an industrial process with a carbon capture system, comprising: (a) providing the industrial process; and (b) retrofitting the industrial process with the carbon capture system, wherein the carbon capture system uses a molten salt to (i) capture carbon dioxide (CO₂) and (ii) desorb the CO₂ to yield desorbed CO₂ and a stream comprising the molten salt, wherein the stream comprises less than 50 mol % steam.

In another aspect, described herein is a system for capturing carbon dioxide (CO₂) from an industrial process, comprising: (a) an absorber that is configured to bring a gaseous stream comprising CO₂ in contact with a first stream comprising a molten salt to thereby absorb the CO₂ from the gaseous stream into the first stream to produce a second stream comprising the molten salt and the absorbed CO₂; and (b) a desorber in fluid communication with the absorber, wherein the desorber is configured to accept the second stream or derivative thereof from the absorber and desorb the absorbed CO₂ of the second stream to thereby generate (i) a third stream comprising the molten salt and (ii) an export stream comprising CO₂ desorbed from the second stream, wherein the third stream comprises less than 50 mol % steam.

In some embodiments, the system further comprises a salt-salt heat exchanger.

In some embodiments, the salt-salt heat exchanger is a tube-in-tube salt-salt heat exchanger.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the systems and methods described herein are set forth with particularity in the appended claims. A better understanding of the features and advantages of the systems and methods described herein will be obtained by reference to the following detailed description that sets forth illustrative embodiments and the accompanying drawings (also “Figure” and “FIG.” herein) of which:

FIG. 1 schematically illustrates a method for capturing carbon dioxide (CO₂) using molten salts, and subsequently desorbing the absorbed CO₂ from the molten salt.

FIG. 2 schematically illustrates a system for capturing CO₂ from solid fuels where an absorber is located in the convection section directly above a desorber in the radiant section.

FIG. 3 schematically illustrates a system for capturing CO₂ from solid fuels where an absorber is located in the convection section parallel to a desorber in the radian section.

FIG. 4 schematically illustrates a system for capturing CO₂ from gaseous fuels where an absorber is located in the convection section directly above a desorber in the radiant section.

FIG. 5 schematically illustrates a system for capturing CO₂ from gaseous fuels where an absorber is located in the convection section parallel to a desorber in the radiant section.

FIG. 6 schematically illustrates a system from capturing CO₂ from gaseous fuels where an absorber in located in the convection section parallel to a desorber in the radiant section, comprising a tube-in-tube heat exchanger.

FIG. 7 shows a computer system that is programmed or otherwise configured to implement a method for capturing CO₂ using molten salts.

FIG. 8 schematically illustrates a system for capturing CO₂ from a high temperature system using molten salts with an integrated heat recovery system using steam tubes.

FIG. 9 schematically illustrates a system for capturing CO₂ from a high temperature system and a flue external to the high temperature system using molten salts.

FIG. 10 schematically illustrates a system for capturing CO₂ from a high temperature system using molten salts, transporting the captured CO₂ for off-site use or storage, and directing steam generated to a steam turbine to obtain electricity.

FIG. 11 schematically illustrates a system for capturing CO₂ from a flue using molten salts and using heat generated from the combustion of a fuel to desorb the captured CO₂.

FIG. 12 schematically illustrates a system for capturing CO₂ from a flue using molten salts, spraying the CO₂-rich molten salt stream into a combustion chamber, and using heat generated from the combustion of a fuel to desorb the captured CO₂.

FIG. 13 schematically illustrates a system for capturing CO₂ from a flue using molten salts and using heat generated from electricity to desorb the captured CO₂.

### DETAILED DESCRIPTION

While various embodiments of the systems and methods described herein have been shown and described herein, it will be obvious to those skilled in the art that such embodiments are provided by way of example only. Numerous variations, changes, and substitutions may occur to those skilled in the art without departing from the systems and methods described herein. It should be understood that various alternatives to the embodiments described herein may be employed. Unless the context requires otherwise, throughout the specification and claims which follow, the word “comprise” and variations thereof, such as, “comprises” and “comprising” are to be construed in an open, inclusive sense, that is, as “including, but not limited to.”

Whenever the term “at least,” “greater than” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “about” as used herein referring to a number or a numerical range means that the number or numerical range referred to is an approximation within experimental variability (or within statistical experimental error). The number or numerical range may vary between 1% and 15% of the stated number or numerical range.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein, the term “high purity” generally refers to a composition with low levels of impurities. In some cases, high purity refers to a mixture with a concentration of a component of about 80% to about 99.99%. In some cases, high purity refers to a mixture with a concentration of a component of about 80% to about 85%, about 80% to about 90%, about 80% to about 95%, about 80% to about 97%, about 80% to about 99%, about 80% to about 99.9%, about 80% to about 99.99%, about 85% to about 90%, about 85% to about 95%, about 85% to about 97%, about 85% to about 99%, about 85% to about 99.9%, about 85% to about 99.99%, about 90% to about 95%, about 90% to about 97%, about 90% to about 99%, about 90% to about 99.9%, about 90% to about 99.99%, about 95% to about 97%, about 95% to about 99%, about 95% to about 99.9%, about 95% to about 99.99%, about 97% to about 99%, about 97% to about 99.9%, about 97% to about 99.99%, about 99% to about 99.9%, about 99% to about 99.99%, or about 99.9% to about 99.99%. In some cases, high purity refers to a mixture with a concentration of a component of about 80%, about 85%, about 90%, about 95%, about 97%, about 99%, about 99.9%, or about 99.99%. In some cases, high purity refers to a mixture with a concentration of a component of at least about 80%, about 85%, about 90%, about 95%, about 97%, about 99%, or about 99.9%.

The term “in proximity to,” as used herein, generally refers to a distance of at most 20 meters between a A and B. For example, if it is stated that the absorber is positioned in proximity to the boiler, it is understood to mean that a boundary of the absorber is at a distance of at most 20 meters from a boundary of the boiler. In some embodiments, the distance may be at most 20 meters (m), 15 m, 10 m, 9 m, 8 m, 7 m, 6 m, 5 m, 4 m, 3 m, 2 m, 1 m, or less.

The term “industrial process,” as used herein, generally refers to a process that extracts, transports, or processes raw materials to manufacture end products using physical, mechanical and/or chemical processes. An industrial process can generate electricity, steam, water, heat, cement, steel, hydrogen, pulp, paper, carbon dioxide, or a combination thereof. In some examples, an industrial process may refer to any process which generates a product of value. In some embodiments, the industrial process may generate carbon dioxide as a by-product (e.g., by-product of combustion). In some embodiments, the industrial process may generate heat (e.g., thermal energy). Examples of industrial processes include coal fired power plants, oil fired power plants, gas fired power plants, or any other fossil-fuel fired power plants. A fossil fuel may comprise coal, petroleum, natural has, oil shales, bitumens, tar sands, and heavy oils.

The term “high temperature system” as used herein generally refers to an entire system or a portion of a system where high temperatures (e.g., exceeding 300° C.) may be reached. An industrial process may comprise one or more high temperature systems. The capture and release of carbon dioxide using molten salts, as described herein, may occur within or in proximity to a high temperature system (e.g., a portion of a system reaching temperatures of at least 300° C.). A high temperature system may comprise a boiler.

The term “carbon capture system” as used herein generally refers to a system comprising at least an absorber and a desorber to capture and release carbon dioxide. A carbon capture system may be a closed-loop system for streams comprising molten salt to move within (e.g., from the absorber to the desorber and back to the absorber). A carbon capture system may be separate from the high temperature system or the system where an industrial process is occurring. A carbon capture system may be integrated directly into a high temperature system (e.g., boiler). A carbon capture system may be positioned near to (e.g., adjacent to) a high temperature system. A carbon capture system may be retroactively fitted (retrofitted) into a pre-existing high temperature system.

### Systems and Methods for CO₂ Capture

Provided herein are systems and methods that may be used to capture carbon dioxide using molten salts.

In one aspect, the present disclosure provides a method for capturing carbon dioxide (CO₂) from an industrial process, comprising: (a) providing a gaseous stream comprising CO₂ generated from an industrial process; (b) contacting the gaseous stream with a first stream comprising a molten salt at an absorber, thereby absorbing CO₂ from the gaseous stream into the first stream to produce a second stream comprising the molten salt and the absorbed CO₂; (c) directing the second stream to a desorber; and (d) using the desorber, desorbing the absorbed CO₂ from the second stream, thereby generating (i) a third stream comprising the molten salt and (ii) an export stream comprising CO₂ desorbed from the second stream, wherein the third stream comprises less than 50 mol % steam.

In some embodiments, the method may further comprise, prior to (c), directing the second stream to a heat exchanger. In some embodiments, the method may further comprise directing the third stream to a heat exchanger. In some embodiments, the heat exchanger may facilitate heat transfer from the third stream to the second salt stream. In some embodiments, the heat exchanger may be a salt-salt heat exchanger.

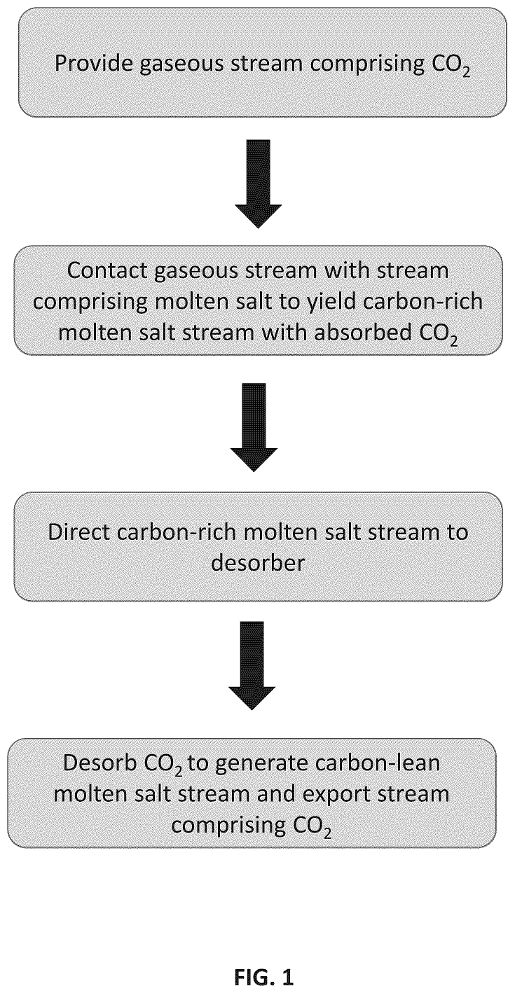

In an example, FIG. 1 shows a process for CO₂ capture. As shown in FIG. 1 a gaseous stream comprising carbon dioxide may first be provided. Then, the gaseous stream comprising carbon dioxide may contact a stream comprising a molten salt, thereby absorbing carbon dioxide into the molten salt and generating a carbon-rich stream. Afterwards, the carbon-rich stream may be directed to a desorber. At the desorber, carbon dioxide is desorbed from the carbon-rich stream thereby generating a carbon-lean stream and an export stream comprising carbon dioxide.

In another aspect, the present disclosure provides a system from capturing carbon dioxide from an industrial process, comprising: (a) an absorber that is configured to bring a gaseous stream comprising carbon dioxide in contact with a first stream comprising a molten salt to thereby absorb the carbon dioxide from the gaseous stream into the first stream to produce a second stream comprising the molten salt and the absorbed carbon dioxide; and (b) a desorber in fluid communication with the absorber, where the desorber is configured to accept the second stream or derivative thereof from the absorbed and desorb the absorbed carbon dioxide of the second stream to thereby generate (i) a third stream comprising the molten salt and (ii) an export stream comprising carbon dioxide desorbed from the second stream, wherein the third stream comprises less than 50 mol % steam.

In some embodiments, heat generated within a system of the industrial process may be used to regenerate the molten salts and release carbon containing material (e.g., carbon dioxide). It may be advantageous to utilize heat generated within the system to regenerate the molten salts and release carbon dioxide to reduce costs and energy requirements associated with regeneration in comparison to other methods. For example, other methods use steam as a sweep gas to regenerate molten salt in the desorber which may require high volumes of steam (e.g., more than 75 mol % of steam in regards to a stream of molten salt). Steam may be generated in an industrial process through heating of boiler feed water, boiling of boiler feed water, or superheating steam. There are practical challenges associated with passing high volumes of superheated steam through a desorber and other sections of a system to recover carbon dioxide from the steam. For example, these challenges may include redesigning, or majorly modifying, the steam turbine, in order to separate a mixture of steam and carbon dioxide, where the steam may condense and the carbon dioxide may remain gaseous. Additionally, using a steam sweep may necessitate a large desorber to support the large flow of steam. Steam sweeps may require maintaining the steam at high pressures, so consideration for the materials used for and durability of the high temperature system to withstand the high pressure required of a steam sweep may present as a challenge. Further, a method of regeneration using a steam sweep may only be applicable in a facility where superheated steam is already being generated (e.g., a large power plant) and may not be feasible in a system where steam is not produced (e.g., a cement kiln, a steel blast furnace).

### High Temperature System

In some embodiments, at least a portion of an industrial process occurs in a high temperature system as described herein. The high temperature system may comprise a boiler, furnace, kiln, reactor, or any combination thereof. In some embodiments, the high temperature system may comprise a system capable of generating carbon dioxide at temperatures of at least 400° C. In some embodiments, the industrial process occurs in a boiler. For example, fuel and air may enter a boiler, where the heat from the boiler may combust the fuel to produce carbon dioxide, among other products (e.g., carbon monoxide, water, nitrogen oxides, sulfur dioxide, ashes). In some embodiments, the industrial process occurs in a kiln. In some embodiments, the industrial process occurs in a reactor. In some embodiments, the industrial process occurs in a furnace. In some cases, the high temperature system is top-fired. In some cases, the high temperature system is bottom fired.

In some cases, a high temperature system operates at a temperature of about 400° C. to about 2,500° C. In some cases, a high temperature system operates at a temperature of about 400° C. to about 500° C., about 400° C. to about 750° C., about 400° C. to about 1,000° C., about 400° C. to about 1,500° C., about 400° C. to about 2,000° C., about 400° C. to about 2,500° C., about 500° C. to about 750° C., about 500° C. to about 1,000° C., about 500° C. to about 1,500° C., about 500° C. to about 2,000° C., about 500° C. to about 2,500° C., about 750° C. to about 1,000° C., about 750° C. to about 1,500° C., about 750° C. to about 2,000° C., about 750° C. to about 2,500° C., about 1,000° C. to about 1,500° C., about 1,000° C. to about 2,000° C., about 1,000° C. to about 2,500° C., about 1,500° C. to about 2,000° C., about 1,500° C. to about 2,500° C., or about 2,000° C. to about 2,500° C. In some cases, a high temperature system operates at a temperature of about 400° C., about 500° C., about 750° C., about 1,000° C., about 1,500° C., about 2,000° C., or about 2,500° C. In some cases, a high temperature system operates at a temperature of at least about 400° C., about 500° C., about 750° C., about 1,000° C., about 1,500° C., or about 2,000° C. In some cases, a high temperature system operates at a temperature of at most about 500° C., about 750° C., about 1,000° C., about 1,500° C., about 2,000° C., or about 2,500° C. In some embodiments, the temperature of at least a portion of the industrial process may exceed a temperature of about 1200° C. In some embodiments, the temperature of at least a portion of the industrial process may exceed a temperature of about 2000° C.

In some embodiments, a reaction process occurring as a part of the industrial process may comprise combustion, gasification, reformation, calcination, smelting, or any other high temperature reaction. In some embodiments, a reaction process occurring as a part of the industrial process may comprise a combination of combustion, gasification, reformation, calcination, smelting, or any other high temperature reaction. In some embodiments, the industrial process may comprise a combustion process. In some embodiments, the industrial process may comprise a gasification process. In some embodiments, the industrial process may comprise a reforming process. In some embodiments, the industrial process may comprise a calcination process. In some embodiments, the industrial process may comprise a smelting process. In some embodiments, the industrial process may comprise a burning a solid fuel. In some embodiments, the industrial process may comprise a burning a gaseous fuel.

A solid fuel as described herein may comprise coal, biomass (e.g., plants and crops), waste, tar, refuse, or any carbon-containing solid. A gaseous fuel as described herein may comprise natural gas, oil, refinery gas, C1-C8 alkane (e.g., methane, propane, butane, pentane, hexane, heptane, octane), or any other carbon-containing gas. A carbon-containing gas as described herein may be any substance in a gaseous state comprising one or more carbon atoms. In some embodiments, a carbon-containing gas may comprise a fossil fuel (e.g., natural gas). In some embodiments, a carbon-containing gas me comprise bio-gas. In some embodiments, a carbon-containing gas may comprise carbon dioxide or carbon monoxide. In some embodiments, a fuel may be a liquid fuel. In some embodiments, a liquid fuel may comprise oil, bio-oil, or any other combustible liquid.

In some embodiments, the industrial process may generate electricity, steam, water, heat, cement, steel, hydrogen, pulp, paper, or a combination thereof. In some embodiments, an industrial process may comprise generating any product of value. In some embodiments, the industrial process may generate carbon dioxide as a by-product. In some embodiments, the industrial process may generate heat (e.g., thermal energy).

In some embodiments, an industrial process comprises one or more unit operations, including a bag house, air heater, boiler, absorber, desorber, heat exchanger, transfer pumps, filters, packing material, low pressure steam turbines, high pressure turbines, condensers, bunkers, fans, super heaters, air heaters, compression units, tanks, storage units, or a combination thereof. An industrial process may comprise a high temperature system. An industrial process may comprise a high temperature system and a carbon capture system. The high temperature system may comprise a boiler. The carbon capture system may comprise an absorber, a desorber, one or more streams, packing material, transfer pumps, heat exchangers, and filters. In some embodiments, the carbon capture process, at least in part, may occur inside of the boiler within a high temperature system. In some embodiments, carbon capture and desorption may occur within a high temperature system or in proximity to a high temperature system. In some embodiments, carbon capture and desorption may occur adjacent to a high temperature system. In some embodiments, carbon capture and desorption may occur within 20 meters to a high temperature system. In some embodiments, carbon capture and desorption may occur within 10 meters to a high temperature system. In some embodiments, carbon capture and desorption may occur within 1 meter to a high temperature system.

In some embodiments, the high temperature system comprises a boiler. The boiler may comprise a radiant section and a convection section. The radiant section of a boiler may comprise an absorber or a desorber as a part of the carbon capture system. The convection section of a boiler may comprise an absorber or a desorber as a part of the carbon capture system. In some embodiments, the radiant section may comprise a desorber and the convection section may comprise an absorber as a part of the carbon capture system. In one embodiment, within a boiler, the convection section may be positioned parallel to the radiant section (e.g., side by side). In another embodiment, within a boiler, the convection section may be positioned above the radiant section (e.g., higher than). In some examples, the convection section may be positioned directly above the radiant section. It may be advantageous to position the convection section parallel to the radiant section to allow enough space to cool down flue gas exiting the radiant section before entering the convection section. It may be advantageous to position the convection section parallel to the radiant section to reduce the total height of the system (e.g., plant). In some embodiments, the industrial process (e.g., reaction process) occurs, at least in part, in a boiler. In some embodiments, the industrial process (e.g., reaction process) occurs in a boiler.

In some embodiments, a radiant section may exceed a temperature of at least about 400° C., 500° C., 600° C., 700° C., 800° C., 900° C., 1000° C., 1200° C., 1400° C., 1600° C., 1800° C., 2000° C., 2500° C., or more. In some embodiments, a radiant section may exceed a temperature of at least about 600° C. In some embodiments, a radiant section may exceed a temperature of at least about 1200° C. In some embodiments, a radiant section may exceed a temperature of at least about 2000° C. In some embodiments, a convection section may exceed a temperature of at least about 100° C., 200° C., 300° C., 400° C., 500° C., 600° C., 700° C., 800° C., 900° C., 1000° C., 1200° C., 1400° C., 1600° C., 1800° C., 2000° C., 2500° C., or more. In some embodiments, a convection section may exceed a temperature of at least about 200° C. In some embodiments, a convection section may exceed a temperature of at least about 400° C. In some embodiments, a convection section may exceed a temperature of at least about 600° C.

In some embodiments, the temperature of a radiant section may be higher than the temperature of a convection section. In some embodiments, the temperature of a radiant section may be at least about 100° C. high than the temperature of the convection section. In some embodiments, the temperature of a radiant section may be at least about 200° C. high than the temperature of the convection section. In some embodiments, the temperature of a radiant section may be at least about 300° C. high than the temperature of the convection section. In some embodiments, the temperature of a radiant section may be at least about 400° C. high than the temperature of the convection section. In some embodiments, the temperature of a radiant section may be at least about 500° C. high than the temperature of the convection section.

The temperature of a radiant section may be controlled or influenced by the relative flow rate of flue gas, fuel, air, steam or any other heat transfer medium into the radiant section of the high temperature system. The temperature of a convection section may be controlled or influenced by the relative flow rate of fuel, air, steam or any other heat transfer medium into the convection section of the high temperature system. In some embodiments, flue gas may comprise a mixture of air and fuel. In some embodiments, heat transfer medium may comprise steam. The ratio between the flow rate of heat transfer medium (e.g., steam) and flue gas may be about 0.01, about 0.1, about 0.5, about 1.0, about 1.5, about 2.0, about 10, about 20, about 30, about 40, about 50, about 60, about 70, about 80, about 90, about 100, or more. In some embodiments, the ratio between the flow rate of heat transfer medium (e.g., steam) and flue gas may be about 0.1 to about 10. In some embodiments, the ratio between the flow rate of heat transfer medium (e.g., steam) and flue gas may be about 1. For example, a lower flow rate of air or fuel may decrease the rate at which carbon dioxide is generated in the boiler, and this may decrease the carbon dioxide that is subsequently captured and releasing heat in the convection section, thereby decreasing the temperature of the convection section.

### Carbon Capture System

A carbon capture system may be a component of a high temperature system used in an industrial process. In some embodiments, the high temperature system may be built or constructed with a carbon capture system component. In some embodiments, a carbon capture system for the absorption and desorption of carbon dioxide as described herein may be retroactively fitted into a system, particularly a high temperature system component, used in an industrial process. For example, a desorber of a carbon capture system may be integrated into a high temperature system. In some embodiments, a desorber may be integrated into a boiler. In some embodiments, a desorber may be integrated into a high temperature system in the form of tubes. The tubes may be heat exchanger tubes. In some embodiments, heat exchanger tubes may be tube-in-tube salt-salt heat exchanger tubes. In some embodiments, a desorber integrated with a high temperature system using tubes may further comprise a tank to allow space for the carbon containing material to desorb from the molten borate salt.

In some examples, the carbon capture system is configured such that the heat generated in a high temperature system (e.g., a boiler) is transferred to a desorber in the carbon capture system. In some embodiments, the heat of reaction is generated in the convection section of the carbon capture system upon absorption of carbon containing material into a stream comprising molten salt. In some embodiments, the heat generated may be passed to a desorber to regenerate the molten salt and carbon containing material. In some embodiments, the desorbed carbon containing material may be high purity carbon containing material (e.g., high purity carbon dioxide).

In some embodiments, a tube-in-tube heat exchanger may be positioned within the high temperature system (e.g., in a boiler) to facilitate transfer of molten salt and heat. In some embodiments, the tube-in-tube heat exchanger may be positioned within the radiant section. In some embodiments, the tube-in-tube heat exchanger may be in the shape of a coil or spiral. In some embodiments, the tube-in-tube heat exchanger may comprise multiple straight sections. In some embodiments, the tube-in-tube heat exchanger may comprise two or more straight sections, where each straight section is positioned relative to an adjacent straight section at an angle between 0 degrees and 180 degrees. In some embodiments, the angle may be between 30 degrees and 120 degrees. In some embodiments, the angle may be about 90 degrees.

In some embodiments, a tube-in-tube heat exchanger may comprise a first tube (e.g., outer tube) which may encompass a second tube (e.g., inner tube). In some embodiments, molten salt may travel up in the outside tube and travel down in the inside tube. In other embodiments, molten salt may travel up in the inside tube and travel down in the outside tube. Molten salt may travel down from the top of a tube to the bottom via gravity. In some embodiments, molten salt and heat may be transferred to the desorber through a plurality of tube-in-tube heat exchangers (e.g., 2 to about 100 tube-in-tube heat exchangers). In some embodiments, molten salt and heat may be transferred to the desorber through one or more tubes. In some embodiments, molten salt and heat may be transferred to the desorber through a single tube. In some embodiments, molten salt and heat may be transferred to the desorber through a plurality of tubes (e.g., 2 to about 100 tubes).

A carbon capture system may comprise an absorber. The absorber may be positioned within a high temperature system of an industrial process. The absorber may be positioned adjacent to a high temperature system of an industrial process. The absorber may be positioned within a boiler of the system. In some embodiments, the absorber may be positioned adjacent to the boiler of the system. In some embodiments, the absorber may be positioned in proximity to the boiler of the system. In some embodiments, the absorber may be positioned within a convection section of the boiler. An absorber may comprise one or more types of molten salt, where the molten salt is used to sequester (e.g., absorb carbon dioxide). The absorber may operate at a temperature of at least 200° C., 300° C., 400° C., 500° C., 600° C., 700° C., 800° C., 900° C., 1000° C., 1200° C., or any other temperature within the preceding range. In some embodiments, the temperature of the absorber may exceed about 400° C. In some embodiments, the temperature of the absorber may exceed about 500° C. In some embodiments, the temperature of the absorber may exceed about 600° C. In some embodiments, the temperature of the absorber may exceed about 700° C. In some embodiments, the temperature of the absorber may be about 300° C. to about 800° C. In some embodiments, the temperature of the absorber may be about 400° C. to about 700° C. In some embodiments, the temperature of the absorber may be about 400° C. to about 600° C.

Molten salt in an absorber may capture at least about 40%, 50%, 60%, 70%, 80%, 90%, 95%, 99%, or 100% of carbon containing material (e.g., carbon dioxide) that it contacts. In some embodiments, an absorber may capture at least about 40%, 50%, 60%, 70%, 80%, 90%, 95%, 99%, or 100% of carbon containing material (e.g., carbon dioxide) that it contacts. The absorber may capture at least about 50% of the carbon containing material it contacts, about 75% of the carbon containing material it contacts, about 80% of the carbon containing material it contacts, about 85% of the carbon containing material it contacts, about 90% of the carbon containing material it contacts, or about 95% of the carbon containing material it contacts.

A carbon capture system may comprise a desorber. The desorber may be positioned within a high temperature system. In some embodiments, the desorber may be positioned adjacent to a high temperature system. In some embodiments, the desorber may be positioned in proximity to a high temperature system. The desorber may be positioned within a boiler of the system. In some embodiments, the desorber may be positioned adjacent to the boiler of the system. In some embodiments, the desorber may be positioned in proximity to the boiler of the system. In some embodiments, the desorber may be positioned within a radiant section of the boiler. A desorber may be used to release, or desorb, carbon dioxide from a molten salt. The desorber may have a temperature of at least 200° C., 300° C., 400° C., 500° C., 600° C., 700° C., 800° C., 900° C., 1000° C., 1200° C., 1400° C., 1600° C., 2000° C., or any other temperature within the preceding range. In some embodiments, the temperature of the desorber may exceed about 700° C. In some embodiments, the temperature of the absorber may exceed about 800° C. In some embodiments, the temperature of the absorber may exceed about 900° C. In some embodiments, the temperature of the absorber may exceed about 1000° C. In some embodiments, the temperature of the absorber may be about 600° C. to about 1200° C. In some embodiments, the temperature of the absorber may be about 700° C. to about 1000° C. In some embodiments, the temperature of the absorber may be about 700° C. to about 900° C.

The desorber may release about 10% of the carbon containing material absorbed within the stream comprising molten salt, about 20% of the carbon containing material absorbed within the stream comprising molten salt, about 30% of the carbon containing material absorbed within the stream comprising molten salt, about 40% of the carbon containing material absorbed within the stream comprising molten salt, about 50% of the carbon containing material absorbed within the stream comprising molten salt, about 60% of the carbon containing material absorbed within the stream comprising molten salt, about 70% of the carbon containing material absorbed within the stream comprising molten salt, about 80% of the carbon containing material absorbed within the stream comprising molten salt, about 85% of the carbon containing material absorbed within the stream comprising molten salt, about 90% of the carbon containing material absorbed within the stream comprising molten salt, about 95% of the carbon containing material absorbed within the stream comprising molten salt, or about 99% of the carbon containing material absorbed within the stream comprising molten salt, or about 100% of the carbon containing material absorbed within the stream comprising molten salt. In some embodiments, the desorber may release about 10% to about 100% of the carbon containing material absorbed within the stream comprising molten salt. In some embodiments, the desorber may release about 40% to about 100% of the carbon containing material absorbed within the stream comprising molten salt. For example, a carbon rich stream comprising molten salt may comprise about 50% carbon dioxide and comprise about 30% carbon dioxide in the carbon lean stream comprising molten salt upon desorption of carbon dioxide, thereby effectively releasing about 40% of the carbon dioxide absorbed in the stream comprising molten salt.

In some embodiments, the desorber may have a temperature that is higher than the absorber. For example, if the absorber has a temperature of about 600° C., then the desorber may have a temperature of at least 900° C. In another example, if the absorber has a temperature of about 700° C., then the desorber may have a temperature of at least 1000° C. The temperature difference between an absorber and a desorber may be at least about 100° C., 200° C., 300° C., 400° C., 500° C., 600° C., or more. In some embodiments, the temperature difference between an absorber and a desorber may be at least about 100° C. In some embodiments, the temperature difference between an absorber and a desorber may be at least about 200° C. In some embodiments, the temperature difference between an absorber and a desorber may be at least about 300° C. In some embodiments, a desorber may consume heat in the radiant section of the high temperature system which may prevent exceedingly high temperatures at the desorber (e.g., at least 1,000° C.). In such embodiments, an exceedingly high temperature at the desorber may be at least 1000° C., at least 1200° C., at least 2000° C., or more. A desorber may reduce heat flux through wing-walls positioned in the radiant section of the high temperature system. In some embodiments, the higher temperature of the desorber (in comparison to the absorber) may facilitate desorption of carbon dioxide from a molten salt.

A high temperature system may comprise one or more wing-walls. A wing-wall may be positioned in the radiant section of the high temperature system to reduce heat flux. Such wing-walls may prevent the radiant section from reaching exceedingly high temperatures and causing damage to the radiant section due to the high temperatures. In some examples, an exceedingly high temperature in the radiant section may be at least 1000° C., at least 1200° C., at least 2000° C., or more. A wing-wall may comprise one or more pipes positioned near, or on, the walls of the radiant section. In some embodiments, the one or more pipes of a wing-wall may be positioned at most about 5 meters from a wall of the radiant section, at most about 2 meters from a wall of the radiant section, at most about 1 meter from a wall of the radiant section, or less. In some embodiments, the one or more pipes of a wing-wall may be positioned on a wall of the radiant section. In some embodiments, the pipes of a wing-wall may comprise feed water from the boiler and may generate steam through contact with hot flue gas. In some embodiments, the pipes of a wing-wall may comprise feed water from a boiler and may generate steam through contact with heat in the desorber. In some embodiments, steam may be generated in a steam drum (e.g., steam tank).

In some embodiments, a carbon capture system may comprise a packed bed, tank, heat exchanger, or a combination thereof. In some embodiments, a carbon capture system may comprise a packed bed and a heat exchanger. In some embodiments, a carbon capture system may comprise a tank and a heat exchanger. In some embodiments, the desorber may comprise packing material. In some embodiments, the desorber may not comprise packing material. The packing material may be a part of a packed bed. The packing material may comprise random packing, structured packing, or a combination thereof. A packed bed may lengthen the duration of time a carbon rich stream resides in the desorber to provide more opportunity for carbon containing material to desorb from the carbon rich stream. In some embodiments, the absorber may comprise packing material. The packing material may be a part of a packed bed. The packing material may comprise random packing, structured packing, or a combination thereof. In some embodiments, the packing material may provide a high surface area for the molten-salt stream to interact with. In some embodiments, the packing material may reduce pressure drop as a stream comprising molten salt passes through the packed bed. In some embodiments, the packing material may comprise a low-cost material. A packing material may comprise a conductive material. In some embodiments, a packing material may comprise a metal, metal alloy, ceramic material, or a combination thereof.

In some embodiments, the carbon capture system may comprise a tank. The tank may comprise a space to allow the carbon containing material released from the carbon rich stream to reside (e.g., CO₂ drum or molten salt drum). In some embodiments, the tank is a flash tank. In some embodiments, the tank is a drum. In some embodiments the tank may contain a mixture of liquid molten salt (e.g., carbon lean molten salt and carbon rich molten salt) and gaseous carbon containing material. In some embodiments, at any given time during the desorption process, the tank may be at least 10% liquid filled, at least 20% liquid filled, at least 50% liquid filled, at least 80% liquid filled, or more. In some embodiments, the tank may comprise a riser tube. In some embodiments the tank may comprise a downcomer tube. In some embodiments the tank may comprise a cyclone. In some embodiments the tank may comprise baffles. A large tank may increase the residence time of the molten salt in the tank, thereby achieving a greater degree of desorption. A large tank may reduce the velocity of a molten salt stream and prevent entrainment of a molten salt stream into the carbon containing material gas stream. A small tank may reduce the residence time of the molten salt in the tank. A small tank may increase heat transfer from the radiant section. A small tank may reduce the total amount of molten salt required in the system. In some embodiments, the residence time of molten salt in the tank may be at least 30 seconds, at least 1 minute, at least 2 minutes, at least 5 minutes, at least 10 minutes, at least 20 minutes. A molten salt stream in a large tank may have a residence time of at least 5 minutes, at least 10 minutes, at least 20 minutes, or more. A molten salt stream in a small tank may have a residence time of at most about 10 minutes, about 5 minutes, about 2 minutes, about 1 minute, about 30 seconds, or less. In some embodiments, a tank may be exposed to hot flue gas. In some embodiments, the pressure of desorbed carbon containing gas in the tank may be controlled by a downstream fan. In some embodiments, the fan may rotate upon contact with a carbon dioxide draft.

In some embodiments, the carbon capture system may comprise a heat exchanger. In some embodiments, the heat exchanger may comprise a helical coil heat exchanger, a tube-in-tube heat exchanger, a printed circuit heat exchanger, a salt-salt heat exchanger, or a combination thereof. In some embodiments, a heat exchanger comprises a salt-salt heat exchanger. In some embodiments, a heat exchanger may comprise a conventional shell and tube heat exchanger comprising a shell-side and a tube-side.

In relation to the desorber, a heat exchanger may be positioned within the carbon capture system at an elevation less than (e.g., lower than) the elevation of the desorber. For example, a heat exchanger may be positioned below a desorber within a carbon capture system. Although measures may be put in to place to limit desorption of carbon containing material in the heat exchanger, some carbon containing material may be desorbed in the heat exchanger. Positioning the heat exchanger at an elevation lower than the desorber may facilitate rising of the desorbed carbon containing material into the desorber. In some embodiments, a heat exchanger may be positioned at an elevation less than the elevation of the desorber by at least 0.01 meters (m), 0.1 m, 0.5 m, 1 m, 2 m, 3 m, 4 m, 5 m, 6 m, 7 m, 8 m, 9 m, 10 m, 12 m, or more. In some embodiments, a heat exchanger may be positioned at an elevation less than the elevation of the desorber by at least 0.1 m. In some embodiments, a heat exchanger may be positioned at an elevation less than the elevation of the desorber by at least 1 m. In some embodiments, a heat exchanger may be positioned at an elevation less than the elevation of the desorber by at least 10 m.

In some embodiments, transfer pumps may be used to facilitate transport of streams within a carbon capture system. In some embodiments, a transfer pump may be used to transport the first stream. In some embodiments, a transfer pump may be used to transport the second stream. In some embodiments, a transfer pump may be used to transport the third stream. In some embodiments, the first stream may be directed through a transfer pump. In some embodiments, the second stream may be directed through a transfer pump. In some embodiments, the third stream may be directed through a transfer pump. In some embodiments, a transfer pump may be used to transport any stream to a location within the carbon capture system.

In some embodiments, a transfer pump may operate with an outlet absolute pressure of at least 0.5 bar, 1 bar, 2 bar, 3 bar, 4 bar, 5 bar, 6 bar, 7 bar, 8 bar, 9 bar, 10 bar, 15 bar, 20 bar, 30 bar, 40 bar, 50 bar, 60 bar, 70 bar, 80 bar, 90 bar, 100 bar, 120 bar, 150 bar, 200 bar, or more. In some embodiments, a transfer pump may operate with an outlet absolute pressure of at least 1 bar. In some embodiments, a transfer pump may operate with an outlet absolute pressure of at least 5 bar. In some embodiments, a transfer pump may operate with an outlet absolute pressure of at least 10 bar. In some embodiments, a transfer pump may operate with an outlet absolute pressure of at least 20 bar. In some embodiments, a transfer pump may operate with an outlet absolute pressure of at least 100 bar.

In some embodiments, a transfer pump may operate at a temperature of at least about 300° C., 400° C., 500° C., 600° C., 700° C., 800° C., 900° C., 1000° C., 1200° C., 1400° C., 1600° C., 2000° C., or more. In some embodiments, a transfer pump may operate at a temperature of at least about 400° C. In some embodiments, a transfer pump may operate at a temperature of at least about 600° C. In some embodiments, a transfer pump may operate at a temperature of at least about 800° C.

A heat exchanger positioned in a path between the absorber and the desorber may be used to raise or lower the temperature of a stream. A heat exchanger may be a salt-salt heat exchanger. A salt-salt heat exchanger may utilize streams of molten salt as the heat exchange fluids. In some embodiments, the salt-salt heat exchanger may raise the temperature of the carbon rich stream and lower the temperature of the carbon lean stream. For example, the salt-salt heat exchange may raise the temperature of carbon rich stream to a temperature sufficient to desorb the carbon dioxide from the molten salt and may lower the temperature of the carbon lean molten salt prior to transporting it back to the absorber for a subsequent cycle of carbon capture. For example, the salt-salt heat exchanger may raise the temperature of a second stream from about 600° C. to about 900° C., and may lower the temperature of the third stream from about 900° C. to about 600° C. For example, the salt-salt heat exchanger may raise the temperature of a second stream from about 600° C. to about 900° C., and may lower the temperature of the third stream from about 900° C. to about 700° C.

In some embodiments, the salt-salt heat exchanger may raise the temperature of the carbon rich stream (e.g., second stream) at least about 50° C., 100° C., 150° C., 200° C., 300° C., 350° C., 400° C., or more. In some embodiments, the salt-salt heat exchanger may utilize heat flux from the radiant section and heat from the returning carbon lean stream (e.g., the third stream) to raise the temperature of the carbon rich salt stream (e.g., stream second stream). In some embodiments, the salt-salt heat exchanger may raise the temperature of the carbon rich salt stream to about the temperature of desorber. In some embodiments, the salt-salt heat exchanger may raise the temperature of the carbon rich salt stream to about the temperature less than that of the desorber by about 20° C., 50° C., 80° C., 100° C., 150° C., 200° C., 250° C., 300° C., or more.

In some embodiments, the salt-salt heat exchanger may lower the temperature of the carbon lean stream (e.g., third stream) at least about 50° C., 100° C., 150° C., 200° C., 300° C., 350° C., 400° C., or more prior to transporting the carbon lean stream to the absorber for a subsequent cycle of carbon capture. In some embodiments, the heat associated with the third stream may be transferred to the carbon rich stream in the salt-salt heat exchanger to raise its temperature. In some embodiments, the heat associated with the third stream may be transferred as thermal energy for use elsewhere in the industrial process or system. In some embodiments, the heat associated with the third stream may be transferred to water to generate steam for use elsewhere in the industrial process or system (e.g., temperature control). Lowering the temperature of the carbon lean stream (e.g., third stream) may also prevent damage to storage tanks or transfer pumps if they are not constructed of material durable to the high temperatures the streams may reach.

In some embodiments, a salt-salt heat exchanger may be located within the carbon capture system such that carbon lean stream leaving the desorber (e.g., third stream) may drain (e.g., through gravitational force) into the salt-salt heat exchanger without the need for a transfer pump. However, a transfer pump for carbon lean stream may be located at the outlet of the salt-salt exchanger. In some embodiments, the salt-salt heat exchanger may be positioned inside of a high temperature system or outside of a high temperature system. In some embodiments, the salt-salt heat exchanger may be positioned inside of a high temperature system. In some embodiments the salt-salt heat exchanger may be at least 1 m in height, at least 2 m, at least 5 m, at least 10 m, at least 20 m. In some embodiments the salt-salt heat exchanger may be at least 0.5 m in width, at least 1 m, at least 2 m, at least 5 m, at least 10 m. In some embodiments the salt-salt heat exchanger may be at least 0.5 m in depth, at least 1 m, at least 2 m, at least 5 m, at least 10 m.

In some embodiments, the carbon capture system may comprise a transfer pump for the carbon rich stream. In such embodiments, the transfer pump may operate at a high pressure in order to increase the partial pressure of carbon containing material through the salt-salt heat exchanger to limit desorption of the carbon containing material in the second stream prior to entering the desorber. In some embodiments, a transfer pump may operate at a pressure of at least about 0.1 bar, 1 bar, 2 bar, 3 bar, 4 bar, 5 bar, 6 bar, 7 bar, 8 bar, 9 bar, 10 bar, 20 bar, 30 bar, 40 bar, 50 bar, or more. In some embodiments, a transfer pump may operate at a pressure from about 1 bar to about 10 bar. In some embodiments, the carbon rich stream may be located on the shell side of a salt-salt heat exchanger such that desorption of carbon containing material does not inhibit downward flow. In some embodiments, the third stream may be directed to the tube-side of a heat exchanger and the second stream may be directed to the shell-side of a heat exchanger.

In some embodiments, one or more filters may be positioned within a path of the streams (e.g., between an absorber and desorber, between a desorber and absorber, adjacent to a heat exchanger). In some embodiments, one or more filters may be positioned on a by-pass line. In some embodiments, one or more filters may be positioned on a slipstream. In some embodiments, one or more filters may be positioned on a main line between a transfer pump and the absorber. In some embodiments, one or more filters may be positioned on a main line between a transfer pump and the desorber. In some embodiments, a filter may be positioned downstream of a carbon lean molten salt transfer pump. The filters may be used to remove solids that may accumulate in the streams. In some embodiments, a filter may retain at least 50%, 60%, 70%, 80%, 90%, or 100% of solids on a first side of the filter. In some embodiments, the first stream may be directed through one or more filters. In some embodiments, the second stream may be directed through one or more filters. In some embodiments, the third stream may be directed through one or more filters.

In another aspect, the present disclosure provides a method for retrofitting an industrial process with a carbon capture system, comprising: (a) providing an industrial process; and (b) retrofitting the industrial process with said carbon capture system, wherein the carbon capture system uses a molten salt to (i) capture carbon dioxide and (ii) desorb the carbon dioxide to yield desorbed CO₂ and a stream comprising the molten salt, wherein the stream comprises less than 50 mol % steam.

### Molten Salt Streams

### Molten Borate Salts

The carbon capture system may use a molten salt. The molten salt may comprise a molten borate salt. The borate salt may comprise a formula of AₓB₁₋ₓO_{1.5-x}. In such formulas, “A” refers to an alkali metal, “B” refers to boron, “O” refers to oxygen, and “x” is a value between 0 and 1.

In some embodiments, “x” is a number between 0 and 1. In some embodiments, “x” is about 0.4, 0.45, 0.5, 0.55, 0.6, 0.65, 0.7, 0.75, 0.8, 0.85, 0.9, 0.91, 0.92, 0.93, 0.94, 0.95, 0.96, 0.97, 0.98, or 0.99. In some embodiments, “x” is a number between about 0.25 and about 0.98. In some embodiments, “x” is a number between about 0.3 and about 0.95. In some embodiments, “x” is a number between about 0.5 and about 0.95. In some embodiments, “x” is a number between about 0.6 and about 0.9. In some embodiments “x” is about 0.75.

In some embodiments, “A” comprises alkali metal. An alkali metal may be lithium (Li), sodium (Na), potassium (K), rubidium (Rb), cesium (Cs), or francium (Fr). In some embodiments, “A” is lithium. In some embodiments, “A” is sodium. In some embodiments, “A” is potassium. In some embodiments, “A” is rubidium. In some embodiments, “A” is cesium. In some embodiments, “A” is francium. In some embodiments, “A” may comprise an alkaline earth metal. An alkali earth metal may be beryllium (Be), strontium (Sr), calcium (Ca), magnesium (Mg), barium (Ba), or radium (Ra). In some embodiments, “A” may be any cation comprising a positive charge of +1. In some embodiments, “A” may comprise a transition metal with a +1 charge (e.g., copper, silver, or any other transition metal). In some embodiments “A” may comprise a transition metal. A transition metal may be scandium (Sc), yttrium (Y), lanthanum (La), actinium (Ac), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), manganese (Mn), technetium (Tc), rhenium (Re), bohrium (Bh), iron (Fe), ruthenium (Ru), osmium (Os), hassium (Hs), cobalt (Co), rhodium (Rh), iridium (Ir), meitnerium (Mt), nickel (Ni), palladium (Pd), platinum (Pt), darmstadtium (Ds), copper (Cu), silver (Ag), gold (Au), roentgenium (Rg), zinc (Zn), cadmium (Cd), mercury (Hg), or copernicium (Cn). In some embodiments, the borate salt may comprise a mixture of metals. A may comprise a mixture of alkali metals, alkaline earth metals, transition metals, or any combination thereof. For example the formula for the borate salt may comprise (A¹_{y}A²_{1-y})ₓB₁₋ₓO_{1.5-x}, where A¹ and A² are each a separate “A” as described herein, “y” is a number between 0 and 1, and “x” is a number between 0 and 1. In some embodiments, a borate salt may comprise a mixture of lithium and sodium. In some embodiments A¹ is lithium and A² is sodium. In some embodiments A¹ is lithium, A² is sodium, y is 0.4, and x is 0.75. In some embodiments A¹ is lithium, A² is sodium, y is 0.5, and x is 0.75. In some embodiments A¹ is lithium, A² is sodium, y is 0.33, and x is 0.75. In some embodiments, the borate salt may comprise a composition of Na_{0.75}B_{0.25}O_{0.75}, (Li_{0.5}Na_{0.5})_{0.75}B_{0.25}O_{0.75}, (Li_{0.4}Na_{0.6})_{0.75}B_{0.25}O_{0.75}, (Li_{0.3}Na_{0.7})_{0.75}B_{0.25}O_{0.75}, (Li_{0.2}Na_{0.8})_{0.75}B_{0.25}O_{0.75}, (Li_{0.1}Na_{0.9})_{0.75}B_{0.25}O_{0.75}, (Li_{0.33}Na_{0.33}K_{0.33})_{0.75}B_{0.25}O_{0.75}, (Li_{0.4}Na_{0.5}K_{0.1})_{0.75}B_{0.25}O_{0.75}, (Li_{0.7}Na_{0.3})_{0.5}B_{0.5}O_{1.0}, (Li_{0.5}Na_{0.5})_{0.83}B_{0.17}O_{0.67}, (Li_{0.7}Na_{0.3})_{0.83}B_{0.17}O_{0.67}, or (Li_{0.3}Na_{0.7})_{0.83}B_{0.17}O_{0.67}.

In some embodiments, a borate salt may comprise an impurity or a contaminant. For example, the impurity may comprise Iron (Fe), Chromium (Cr), Nickel (Ni), Manganese (Mn), Molybdenum (Mo), Cobalt (Co), Vanadium (V), Copper (Cu), Zinc (Zn), Aluminum (Al), Titanium (Ti), Cadmium (Cd), Mercury (Hg), Potassium (K), Magnesium (Mg), Silicon (Si), Phosphorus (P), and Sulfur (S), or any other contaminants. A quantity of an impurity in the borate salt may be at most about 30 weight percent (wt %), 20 wt %, 10 wt %, 5 wt %, 2 wt %, 1 wt %, 0.5 wt %, 0.1 wt %, 0.08 wt %, 0.05 wt %, 0.01 wt %, 0.005 wt %, 0.001 wt %, or less.

In some embodiments, a borate salt comprising the formula A_{0.75}B_{0.25}O_{0.75} may be represented as A₃BO₃. In some embodiments, a borate salt comprising the formula A_{0.5}B_{0.5}O_{1.0} may be represented as ABO₂. In some embodiments, a borate salt comprising the formula A_{0.83}B_{0.17}O_{0.67} may be represented as A₅BO₄.

### Molten Salt Streams

The carbon capture system may comprise one or more streams comprising a molten salt. In some embodiments, each stream of the one or more streams may comprise a molten borate salt. In some embodiments, the system or process may comprise a plurality of streams, where the composition of at least one stream of the plurality of streams is different.

A first stream may refer to a stream of molten salt that is fed to an absorber. A second stream may refer to a stream generated from contacting the gaseous carbon containing material with molten salt (e.g., the first stream) in an absorber. A third stream may refer to a stream subsequent to desorption of carbon containing material. The third stream and the first stream may be carbon lean streams. The second stream may be a carbon rich stream. In some embodiments, the concentration of carbon in each stream is relevant. For example, a carbon lean stream (e.g., first or third stream) may comprise a small quantity of carbon containing material, however, the concentration of carbon containing material in a first stream or a third stream is lower than the concentration of carbon containing material in the second stream (e.g., carbon rich stream). A first stream may comprise, at least in part, regenerated molten salt from the third stream. For example, the first stream may comprise at least a portion of the third stream. A first stream may be the regenerated stream (e.g., the third stream). A first stream may comprise the regenerated stream in addition to fresh molten salt. The fresh molten salt may be combined with the third stream to form the first stream. The concentration of carbon containing material of the first stream and the third stream may be the same or different.

In some embodiments, the first stream may comprise a concentration of carbon containing material (e.g., carbon dioxide, carbon monoxide) of at least about 0.01 moles per kilogram of molten salt (mol/kg), 0.05 mol/kg, 0.1 mol/kg, 0.5 mol/kg, 1.0 mol/kg, 1.5 mol/kg, 2 mol/kg, 3 mol/kg, 4 mol/kg, 5 mol/kg, or 6 mol/kg. In some embodiments, the first stream may comprise a concentration of carbon containing material of at least about 0.01 mol/kg to about 4 mol/kg. In some embodiments, the first stream may comprise a concentration of carbon containing material of at least about 2 mol/kg to about 4 mol/kg. In some embodiments, the first stream comprises no carbon containing material. In some embodiments, the first stream may comprise a concentration of carbon containing material of at least 0.01 mol/kg of molten salt. In some embodiments, the first stream may comprise a concentration of carbon containing material of at least 3 mol/kg of molten salt. In some embodiments, the first stream may comprise a concentration of carbon containing material of at least 4 mol/kg of molten salt.

In some embodiments, the second stream may comprise a concentration of carbon containing material (e.g., carbon dioxide, carbon monoxide) of at least about 0.1 moles per kilogram of molten salt (mol/kg), 1 mol/kg, 5 mol/kg, 6 mol/kg, 7 mol/kg, 8 mol/kg, 9 mol/kg, 10 mol/kg, 20 mol/kg, or more. In some embodiments, the second stream may comprise a concentration of carbon containing material of at least 5 mol/kg of molten salt. In some embodiments, the second stream may comprise a concentration of carbon containing material of at least 10 mol/kg of molten salt. The concentration of carbon containing material in the second stream may always be greater than the concentration of carbon containing material in the first stream.

In some embodiments, the third stream may comprise a concentration of carbon containing material (e.g., carbon dioxide, carbon monoxide) of at least about 0.01 moles per kilogram of molten salt (mol/kg), 0.05 mol/kg, 0.1 mol/kg, 0.5 mol/kg, 1.0 mol/kg, 1.5 mol/kg, 2 mol/kg, 3 mol/kg, 4 mol/kg, 5 mol/kg, or 6 mol/kg. In some embodiments, the first stream may comprise a concentration of carbon containing material of at least about 0.01 mol/kg to about 4 mol/kg. In some embodiments, the first stream may comprise a concentration of carbon containing material of at least about 2 mol/kg to about 4 mol/kg. In some embodiments, the third stream comprises no carbon containing material. In some embodiments, the third stream may comprise a concentration of carbon containing material of at least 0.01 mol/kg of molten salt. In some embodiments, the third stream may comprise a concentration of carbon containing material of at least 3 mol/kg of molten salt. In some embodiments, the third stream may comprise a concentration of carbon containing material of at least 4 mol/kg of molten salt. The concentration of carbon containing material in the second stream may always be greater than the concentration of carbon containing material in the third stream.

In some embodiments, the first stream and the third stream may be referred to as a carbon lean molten salt streams herein. In some embodiments, the second stream may be referred to as a carbon rich stream herein. A carbon lean stream may comprise at least some quantity of a carbon containing material. In some embodiments, the carbon lean stream may comprise no carbon containing material. As described herein, the carbon lean stream comprises a lower concentration of carbon containing material when compared to the concentration of carbon containing material in a carbon rich stream.

### Carbon Capture and Molten Salt Regeneration

A process for absorbing carbon dioxide in a molten salt and regenerating the molten salt and carbon dioxide in a desorber are described herein. An absorber may be used to contact a gaseous carbon containing material (e.g., carbon dioxide, carbon monoxide) with a molten salt, described elsewhere herein, thereby transferring the gaseous carbon containing material to a liquid stream of the molten salt. A stream comprising absorbed carbon containing material may be referred to as a carbon rich stream or a rich stream herein. The rich stream is directed to a desorber where the molten salt may be regenerated and a stream comprising desorbed carbon containing material may be further cooled, compressed, and/or prepared for export elsewhere in the system or outside of the system. For example, desorbed carbon containing material may be exported for injecting into geological formations, or converted to products like fuel or other chemicals. The regenerated molten salt may also be referred to as carbon lean molten salt or lean molten salt herein. The lean molten salt may be transferred back to the absorber for another cycle of carbon capture.

The absorber may be located in a convective section of the high temperature system such that flue gas (e.g., exhaust gas) may flow upwards towards the absorber and molten salt (e.g., a first third stream) may flow downward towards the absorber. Upon contacting the flue gas, containing the carbon containing material, with a stream comprising molten salt (e.g., the first stream), an exothermic reaction may occur as the carbon containing material is reacts and is absorbed into the borate salt. The heat generated from the exothermic reaction may be captured in-situ and may be used to heat process fluid within tubes integrated throughout the packing material in a packed bed of the convection section, thereby recovering energy. In some embodiments, the process fluid is water to generate steam. In some embodiments, the process fluid is steam to generate superheated steam. In some embodiments, the process fluid is air to generate hot air or pre-heater air. In some embodiments, a process fluid may comprise a combination of water, steam, and air. The flow of heat transfer medium (e.g., steam) through the tubes may control the temperature of the absorber. In some embodiments, the packing material of the absorber is integrated with the exchanger (e.g., salt-salt heat exchanger). In such embodiments, the heat exchanger may comprise steam bundles for the generation of steam. A steam bundle may comprise one or more pipes located inside a boiler which comprise water. A steam bundle may be referred to herein as a water tube or a wing wall.

Absorption of carbon containing material alter the structure of the initial borate salt. For example, carbon dioxide may react with a borate salt to form a carbonate and an altered borate salt as shown below:

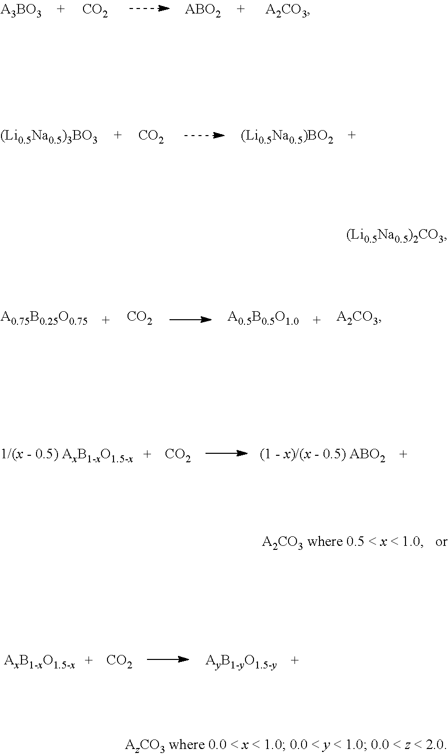

The reaction between a borate salt and carbon dioxide may be reversible. In some embodiments, the resulting carbonate (A₂CO₃) is a liquid. In some embodiments, other components of the flue gas (e.g., components which were not absorbed by the borate salt) may exit the system through an exhaust stack.

The method and systems described herein may comprise a small amount of steam in the process of desorbing carbon containing material from a stream comprising molten salt. In some embodiments, steam may occupy ahead space in proximity to carbon rich stream during desorption. In some embodiments, for at least a portion of the time during which desorption is performed, a head space may contain steam in an amount of at most 70 weight percent (wt %), 60 wt %, 50 wt %, 40 wt %, 30 wt %, 20 wt %, 10 wt %, 5 wt %, 1 wt %, or less. In some embodiments, for at least a portion of the time during which desorption is performed, a head space may contain about 0 wt % steam. In some embodiments, for at least a portion of the time during which desorption is performed, a head space may contain no detectable amount of steam. The remaining volume in the head space may comprise carbon containing gas.

In some embodiments, the molar ratio of steam in the gas phase to carbon containing material absorbed in the carbon rich stream (e.g., second stream) in the desorber during desorption may be, at least for a portion of the time during which desorption occurs, at most 1, at most 0.9, 0.8, 0.7, 0.6, 0.5, 0.4, 0.3, 0.2, 0.1, 0.05, or less. In some embodiments, the molar ratio of steam in the gas phase to carbon containing material absorbed in the carbon rich stream may be 0.

In some embodiments, the molar ratio of steam in the gas to molten salt in the desorber may be at most 0.1, 0.05, 0.01, or less. In some embodiments, the molar ratio of steam in the gas to molten salt in the desorber may be 0.

In some embodiments, the second stream transported to the desorber may contain steam in an amount of at most 70 mol %, 60 mol %, 50 mol %, 40 mol % steam, 30 mol % steam, 20 mol % steam, 10 mol % steam, 5 mol % steam, 2 mol % steam, 1 mol % steam, 0.5 mol % steam, or less. In some embodiments, the second stream may comprise about 0 mol % steam. In some embodiments, the second stream may comprise no steam. In some embodiments, the second stream may have no detectable steam.

In some embodiments, the stream comprising regenerated molten salt (third stream) may comprise less than 50 mole percent (mol %) steam, 40 mol % steam, 30 mol % steam, 20 mol % steam, 10 mol % steam, 5 mol % steam, 2 mol % steam, 1 mol % steam, 0.5 mol % steam, or less. In some embodiments, the third stream may comprise less than 20 mol % steam. In some embodiments, the third stream may comprise less than 10 mol % steam. In some embodiments, the third stream may comprise less than 5 mol % steam. The method and systems described herein may not use steam in the process of desorbing carbon containing material from a molten salt stream during the regeneration process. In some embodiments, the third stream may comprise about 0 mol % steam. In some embodiments, the third stream may comprise no steam. In some embodiments, the third stream may have no detectable steam.

Desorbed carbon containing material may be prepared for export from the desorber. In some cases, desorbed carbon containing material may be stored on site. In some embodiments, the desorbed carbon containing material may be provided as an export stream. In some embodiments, the export stream may comprise a concentration of carbon containing material (e.g., carbon dioxide) at a concentration of at least about 50%, 60%, 70%, 80%, 90%, 95%, 99%, 99.9%, or more. In some embodiments, the export stream may comprise a concentration of carbon containing material at a concentration of at least about 80%. In some embodiments, the export stream may comprise a concentration of carbon containing material at a concentration of at least about 90%. In some embodiments, the export stream may comprise a concentration of carbon containing material at a concentration of at least about 95%. In some embodiments, the export stream may comprise a concentration of carbon containing material at a concentration of at least about 99%. In some embodiments, the export stream may comprise a concentration of carbon containing material at a concentration of at least about 99.9%.

In some embodiments, the export stream may pass through the convection section of the high temperature system. Passing the export stream through the convection section may cool the stream and recover heat through generation of steam, or transfer of heat to another process fluid.

### Computer Systems

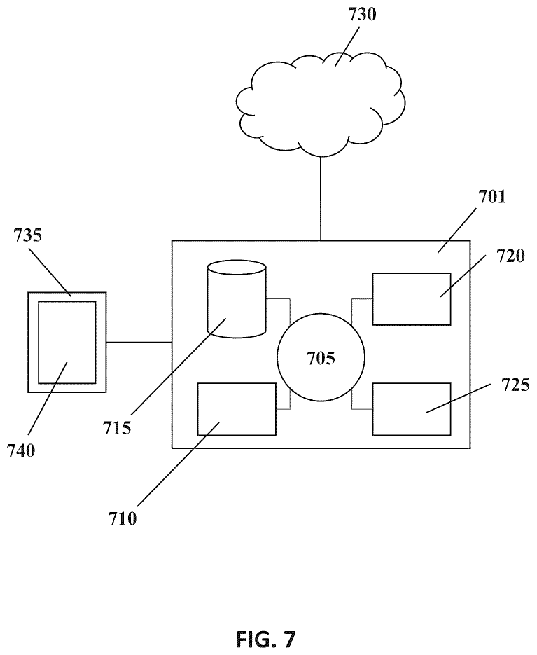

In an aspect, the present disclosure provides computer systems that are programmed or otherwise configured to implement methods of the disclosure, e.g., any of the subject methods for capturing carbon dioxide using molten salts. FIG. 7 shows a computer system 701 that is programmed or otherwise configured to implement a method for capturing carbon dioxides using molten salts. The computer system 701 may be configured to, for example, control the flow of carbon dioxide into the system or to monitor energy output as discussed elsewhere herein. The computer system 701 can be an electronic device of a user or a computer system that is remotely located with respect to the electronic device. The electronic device can be a mobile electronic device.

The computer system 701 may include a central processing unit (CPU, also “processor” and “computer processor” herein) 705, which can be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communication bus (solid lines), such as a motherboard. The storage unit 715 can be a data storage unit (or data repository) for storing data. The computer system 701 can be operatively coupled to a computer network (“network”) 730 with the aid of the communication interface 720. The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730, in some cases with the aid of the computer system 701, can implement a peer-to-peer network, which may enable devices coupled to the computer system 701 to behave as a client or a server.

The CPU 705 can execute a sequence of machine-readable instructions, which can be embodied in a program or software. The instructions may be stored in a memory location, such as the memory 710. The instructions can be directed to the CPU 705, which can subsequently program or otherwise configure the CPU 705 to implement methods of the present disclosure. Examples of operations performed by the CPU 705 can include fetch, decode, execute, and writeback.

The CPU 705 can be part of a circuit, such as an integrated circuit. One or more other components of the system 701 can be included in the circuit. In some cases, the circuit is an application specific integrated circuit (ASIC).

The storage unit 715 can store files, such as drivers, libraries and saved programs. The storage unit 715 can store user data, e.g., user preferences and user programs. The computer system 701 in some cases can include one or more additional data storage units that are located external to the computer system 701 (e.g., on a remote server that is in communication with the computer system 701 through an intranet or the Internet).

The computer system 701 can communicate with one or more remote computer systems through the network 730. For instance, the computer system 701 can communicate with a remote computer system of a user (e.g., an operator overseeing or monitoring the capturing of carbon dioxide or energy output, etc.). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 701 via the network 730.

Methods as described herein can be implemented by way of machine (e.g., computer processor) executable code stored on an electronic storage location of the computer system 701, such as, for example, on the memory 710 or electronic storage unit 715. The machine executable or machine readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 can include or be in communication with an electronic display 735 that comprises a user interface (UI) 740 for providing, for example, a portal for a user to monitor or track one or more processes for fabricating flexible film materials from waste cooking oil and compounds derived therefrom. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 705. For example, the algorithm may be configured to adjust an operation of the system depending on energy needs (e.g., decrease in energy output or increase in energy output).

### Examples

### Example 1: CO₂ Capture Via Solid Fuels, where Absorber is Located Directly Above Desorber

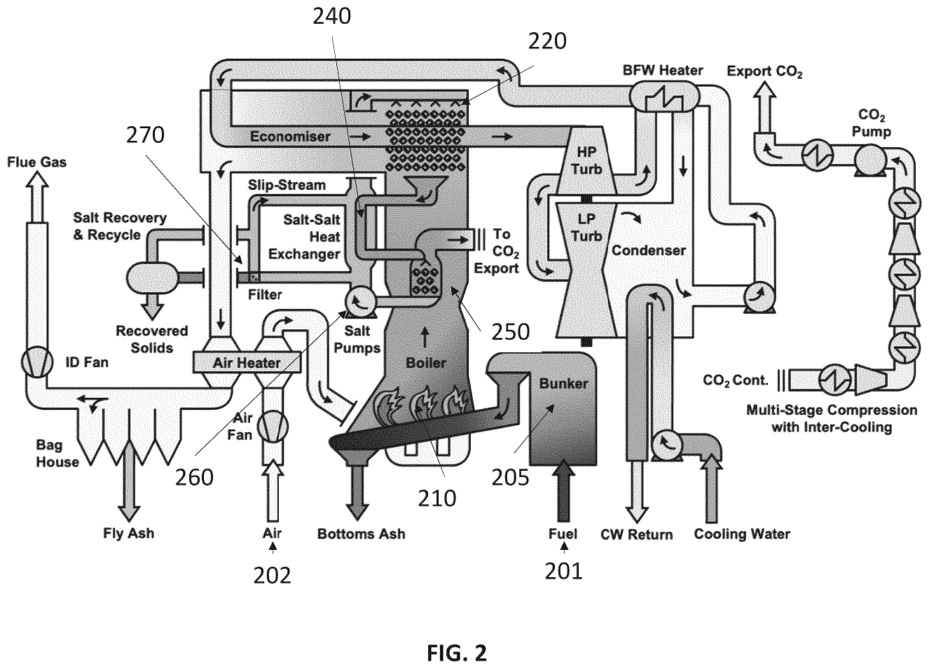

A process for capturing carbon dioxide from solid fuels where the absorber is located in the convection section directly above the desorber in the radiant section is illustrated in FIG. 2. A solid fuel (201) may enter the high temperature system through a bunker (205) and combust when contacted with air (202) in the boiler (210). Within the boiler (210), the carbon dioxide produced as a by-product of combustion (not shown) may be directed the absorber (220). In some cases, molten borate salt enters the absorber from the top (CO₂ lean stream), trickles down the packed bed where it contacts carbon dioxide, and collects at the bottom of the absorber as a CO₂ rich stream. The CO₂ rich stream may be directed to a salt-salt heat exchanger (240) via gravity prior to entering the desorber (250). In the desorber (250), CO₂ is desorbed from the molten salt and exits to be prepared for export elsewhere in the system. The CO₂ lean molten salt is then directed to a salt pump (260) and back through the salt-salt heat exchanger (240). The CO₂ lean stream is then passed through a filter (270) to separate any solids before being directed back to the absorber (220) and used for another cycle of CO₂ capture. The absorber may have a temperature of about 600° C. while the desorber has a temperature of about 900° C.

### Example 2: CO₂ Capture Via Solid Fuels, where Absorber is Located Parallel to Desorber

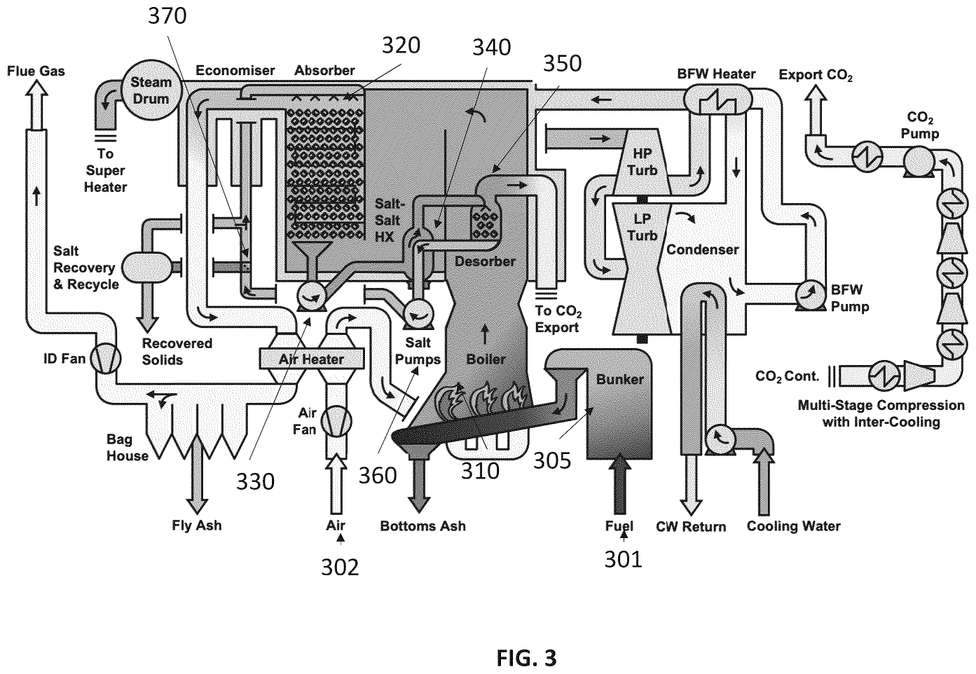

A process for capturing carbon dioxide from solid fuels, where the absorber in the convection section is located parallel to the desorber in the radiant section is illustrated in FIG. 3. A solid fuel (301) may enter the high temperature system through a bunker (305) and combust when contacted with air (302) in the boiler (310). Within the boiler (210), the carbon dioxide produced as a by-product of combustion (not shown) may be directed the absorber (320). Molten borate salt enters the absorber from the top (CO₂ lean stream), trickles down the packed bed where it contacts carbon dioxide, and collects at the bottom of the absorber as a CO₂ rich stream. The CO₂ rich stream may be directed to a transfer pump (330) before being directed through a salt-salt heat exchanger (340) and ultimately to a desorber (350). In the desorber (350), CO₂ is desorbed from the molten salt and exits to be prepared for export elsewhere in the system while the CO₂ lean stream is directed back through the salt-salt heat exchanger (340). The CO₂ lean molten salt is then directed to a salt pump (360) and passed through a filter (370) to separate any solids before being directed back to the absorber (320) and used for another cycle of CO₂ capture. The absorber may have a temperature of about 600° C. while the desorber has a temperature of about 900° C.

### Example 3: CO₂ Capture Via Gaseous Fuels, where Absorber is Located in the Convection Section Directly Above the Desorber in the Radiant Section

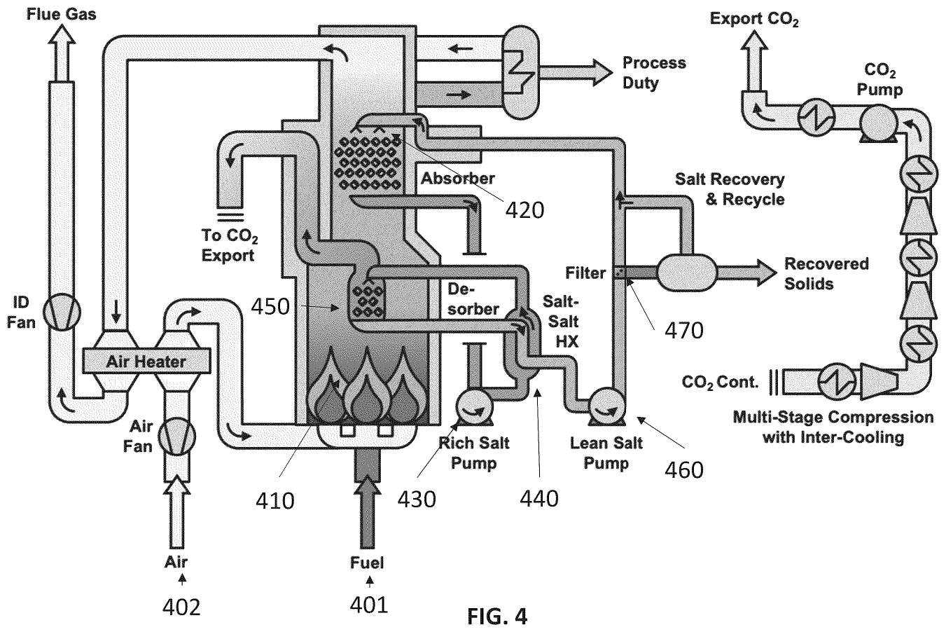

A process for capturing carbon dioxide from gaseous fuels where the absorber is located in the convection section directly above the desorber in the radiant section is illustrated in FIG. 4. A gaseous fuel (401) may enter the high temperature system comprising a boiler (410) where it contacts air (402) and combusts. Within the boiler (410), the carbon dioxide produced as a by-product of combustion (not shown) may be directed the absorber (420). Molten borate salt enters the absorber from the top (CO₂ lean stream), trickles down the packed bed where it contacts carbon dioxide, and collects at the bottom of the absorber as a CO₂ rich stream. The CO₂ rich stream may be directed to through a rich salt pump (430) prior to being directed to a salt-salt heat exchanger (440) before ultimately entering the desorber (450). In the desorber (450), CO₂ is desorbed from the molten salt and exits to be prepared for export elsewhere in the system. The CO₂ lean molten salt is directed back to the salt-salt heat exchanger (440) and then to a salt pump (460). The CO₂ lean molten salt is passed through a filter (470) to separate any solids before being directed back to the absorber (420) and used for another cycle of CO₂ capture. The absorber may have a temperature of about 600° C. while the desorber has a temperature of about 900° C.

### Example 4: CO₂ Capture Via Gaseous Fuels, where Absorber is Located Parallel to Desorber

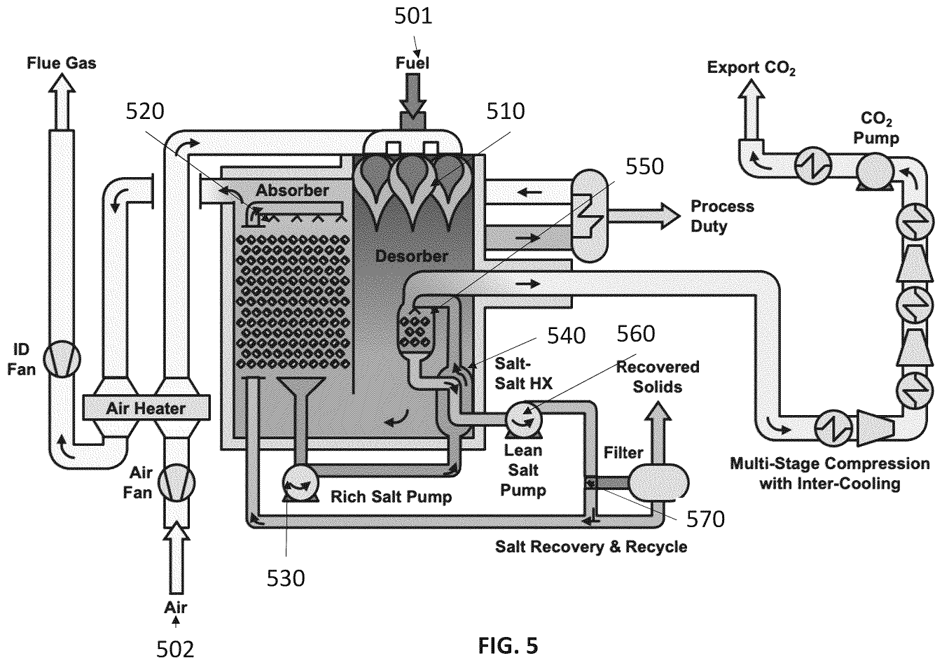

A process for capturing carbon dioxide from gaseous fuels, where the absorber in the convection section is located parallel to the desorber in the radiant section is illustrated in FIG. 5. A gaseous fuel (501) may enter the high temperature system comprising a boiler (510) where it contacts air (502) and combusts. Within the boiler (510), the carbon dioxide produced as a by-product of combustion (not shown) may be directed the absorber (520). Molten borate salt enters the absorber from the top (CO₂ lean stream), trickles down the packed bed where it contacts carbon dioxide, and collects at the bottom of the absorber as a CO₂ rich stream. The CO₂ rich stream may be directed to through a rich salt pump (530) prior to being directed to a salt-salt heat exchanger (540) before ultimately entering the desorber (550). In the desorber (450), CO₂ is desorbed from the molten salt and exits to be prepared for export elsewhere in the system. The CO₂ lean molten salt is directed back to the salt-salt heat exchanger (540) and then to a salt pump (560). The CO₂ lean molten salt is passed through a filter (570) to separate any solids before being directed back to the absorber (520) and used for another cycle of CO₂ capture. The absorber may have a temperature of about 600° C. while the desorber has a temperature of about 900° C.

### Example 5: CO₂ Capture Via Gaseous Fuels, where Absorber is Located Parallel Above Desorber with a Tube-In-Tube Heat Exchanger

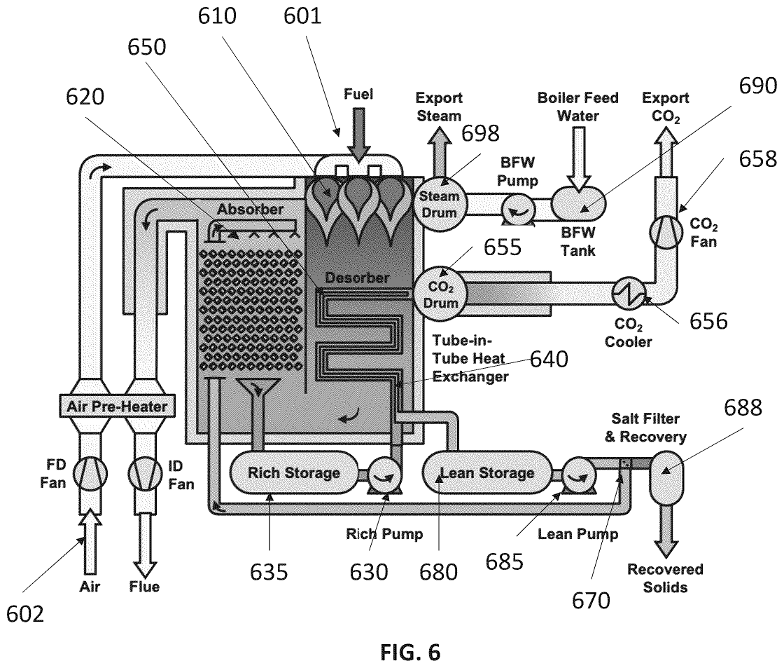

A process for capturing carbon dioxide from gaseous fuels, where the absorber in the convection section is located parallel to the desorber in the radiant section, further comprising storage compartments is illustrated in FIG. 6. A gaseous fuel (601) may enter the high temperature system comprising a boiler (610) where it contacts air (602) and combusts, thereby producing flue gas. Within the boiler (610), carbon dioxide in the flue gas may be directed to the absorber (620), while the remaining flue gas is directed out of the system. Molten borate salt enters the absorber from the top (carbon lean molten stream), trickles down the packed bed where it contacts carbon dioxide, and collects at the bottom of the absorber as a carbon rich stream in a storage compartment (635). The carbon rich molten salt may be transferred to a tube-in-tube heat exchanger (640) via a pump (630). The desorber (650) comprises the tube-in-tube heat exchanger (640) where carbon rich molten salt travels up the outer tube (not shown) of the tube-in-tube heat exchanger (640), where carbon dioxide is released. Carbon lean molten salt may travel back down the inner tube (not shown) of the tube-in-tube heat exchanger (640) and enter a storage compartment (680). The carbon lean molten salt in the storage compartment (680) may be directed through a pump (685) and passed through a filter (670) before entering the absorber (620) again. Released carbon dioxide may reside in a carbon dioxide drum (655) before the carbon dioxide is directed through a cooler (656) and fan (658) for export elsewhere in the system. Separately, steam may generated in a steam drum (698) where boiler feed water from a tank (690) contacts heat from the boiler (610). The boiler feed water may be used to regulate the temperatures in the convection section of the high temperature system, while excess steam may be exported from the steam drum (698).

### Example 6: CO₂ Capture and Heat Recovery

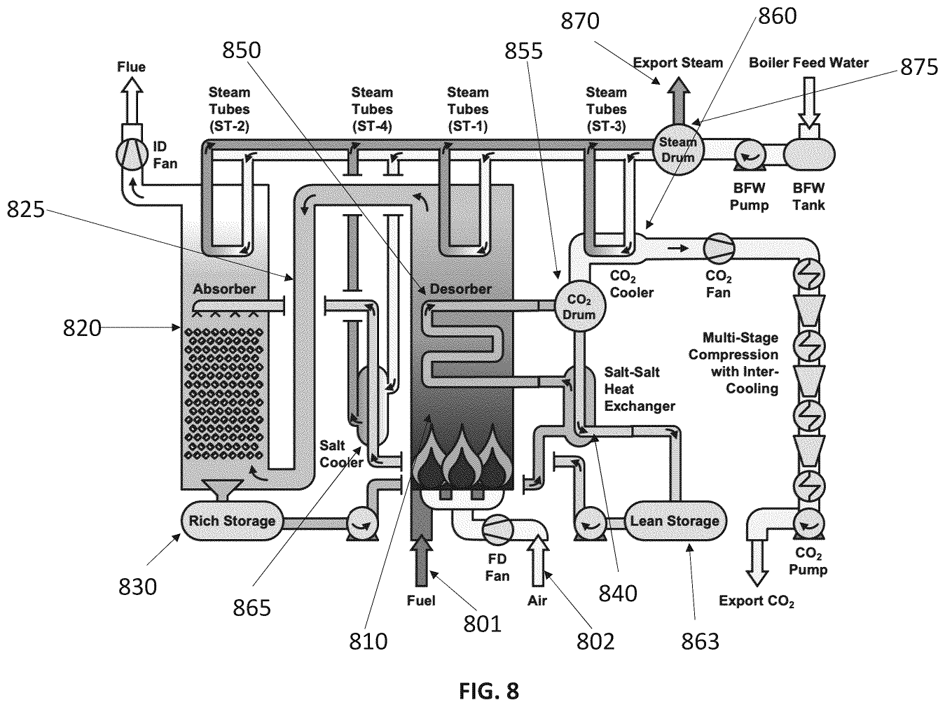

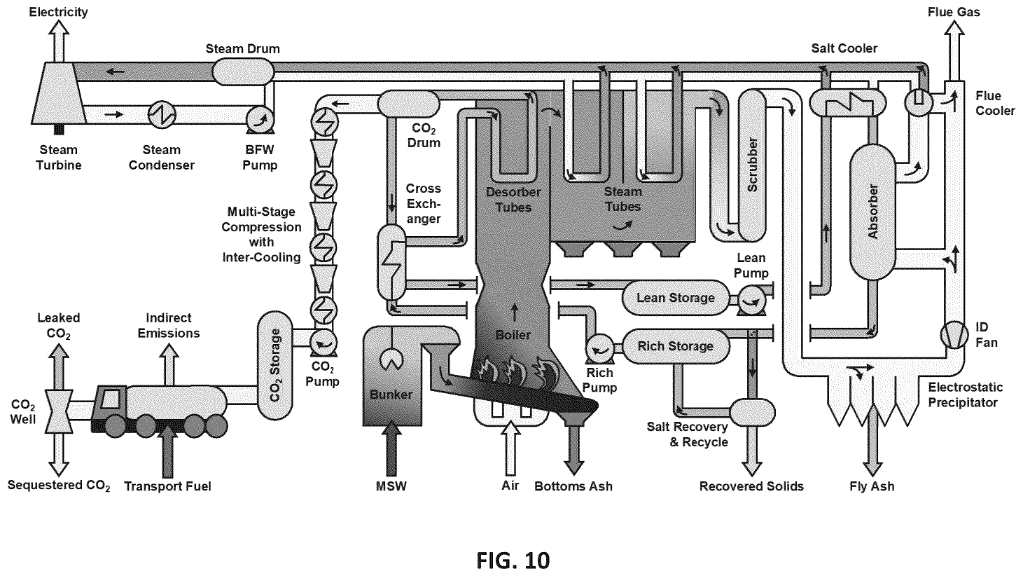

A process for capturing carbon dioxide from is illustrated in FIG. 8. The carbon dioxide (CO₂) may be produced as a byproduct of an industrial process. The industrial process may include fuel combustion in a high temperature system (810). The high temperature system may be a chamber of a boiler where fuel is burned (i.e., a firebox). A fuel (801) may enter the high temperature system and combust when contacted with air (802), thereby producing CO₂. Heat generated in the high temperature system may be transferred to piping or tubing with liquid water and can be used to heat liquid water to gaseous steam in steam tubes (ST-1). Alternatively, another heat fluid may be used. The CO₂ produced as a by-product of combustion may be directed to the absorber (820). The CO₂ may exit the high temperature system near the top and be fed to the bottom of the absorber (820) via a line (825). In some cases, a molten borate salt enters the absorber from the top, trickles down the packed bed where it contacts and captures at least a portion of the CO₂, thereby obtaining a CO₂-rich molten salt stream. The CO₂-rich molten salt stream may collect at the bottom of the absorber. Heat generated in the absorber may be transferred to piping or tubing with liquid water and can be used to heat liquid water to gaseous steam in steam tubes (ST-2). The CO₂-rich molten salt stream may be stored for a period of time in rich storage tank (830). The CO₂-rich molten salt stream may be directed to a salt-salt heat exchanger (840) using one or more pumps. After exiting the salt-salt heat exchanger (840), the CO₂-rich molten salt stream may be directed to a desorber (850). The desorber (850) may be located entirely or partially within the high temperature system (810). The heat generated from the high temperature system (i.e., boiler), may facilitate desorption of CO₂ from the molten salt. The desorber (850) may be a series of pipes or tubes located within the high temperature system (810). The desorber (850) may be in a coiled configuration. In the desorber (850), CO₂ can be desorbed from the molten salt, thereby resulting in a CO₂-lean molten salt stream and a CO₂ stream. A CO₂ drum (855) may be used to separate the CO₂ stream and the CO₂-lean molten salt stream. The CO₂ may be cooled using a CO₂ cooler (860). The CO₂ cooler (860) may include a stream of liquid water, which is used to cool the CO₂. At the CO₂ cooler, the CO₂ may heat the water. The liquid water may be heated such that it exits the CO₂ cooler as gaseous steam in steam tubes (ST-3). After exiting the CO₂ cooler (860), the CO₂ may be processed for export. The CO₂ may enter a multi-stage compression system with inter-cooling. The CO₂ can be transported and used off-site or stored (see FIG. 10). In some cases, the captured CO₂ is stored underground.

The CO₂-lean molten salt stream may exit the CO₂ drum (855) and be directed to the salt-salt heat exchanger (840). The salt-salt heat exchanger (840) can facilitate heat transfer from the CO₂-lean molten salt stream to the CO₂-rich molten salt stream, thus heating the CO₂-rich molten salt stream prior to entering the desorber (850). After exiting the salt-salt heat exchanger (840), the CO₂-lean molten salt stream may be stored for a period of time in lean storage tank (863). The CO₂-lean molten salt stream can be directed to a salt cooler (865). The salt cooler (865) can be used to transfer heat from the CO₂-lean molten salt stream to another fluid. In some cases, heat transferred from the CO₂-lean molten salt stream at the salt cooler (865) can be recovered. In some cases, heat transferred from the CO₂-lean molten salt stream at the salt cooler (865) can be used to preheat air. In some cases, heat transferred from the CO₂-lean molten salt stream at the salt cooler (865) can be used to heat water. Liquid water may be heated such that it exits the salt cooler as gaseous steam in steam tubes (ST-4). The CO₂-lean molten salt stream may then exit the salt cooler (865) and enter the absorber (820) to capture additional CO₂. Steam produced at any point in the system can exit the system as export steam. Steam from steam tubes ST-1, ST-2, ST-3, and ST-4 may be combined and exit the system through one export stream (870). Prior to exiting the system, steam may pass through a steam drum (875). Export stream (870) may be fed to a steam turbine, which can be used to convert thermal energy in the steam to electricity (see FIG. 10). Steam tubes ST-1, ST-2, ST-3, and ST-4 may be fluidically connected to a single water source or multiple water sources. Water may be pumped from a single source (i.e., a water tank) and partially diverted at various points in the system. A first portion of water may be diverted to the CO₂ cooler (860), where it is heated into steam, which flows through steam tubes ST-3. A second portion of water may be diverted to recover heat from the high temperature system, where it is heated into steam, which flows through steam tubes ST-1. A third portion of water may be diverted to the salt cooler (865), where it is heated into steam, which flows through steam tubes ST-3. A fourth portion of water may be diverted to recover heat from the absorber, where it is heated into steam, which flows through steam tubes ST-2.

### Example 7: CO₂ Capture From Multiple CO₂ Sources

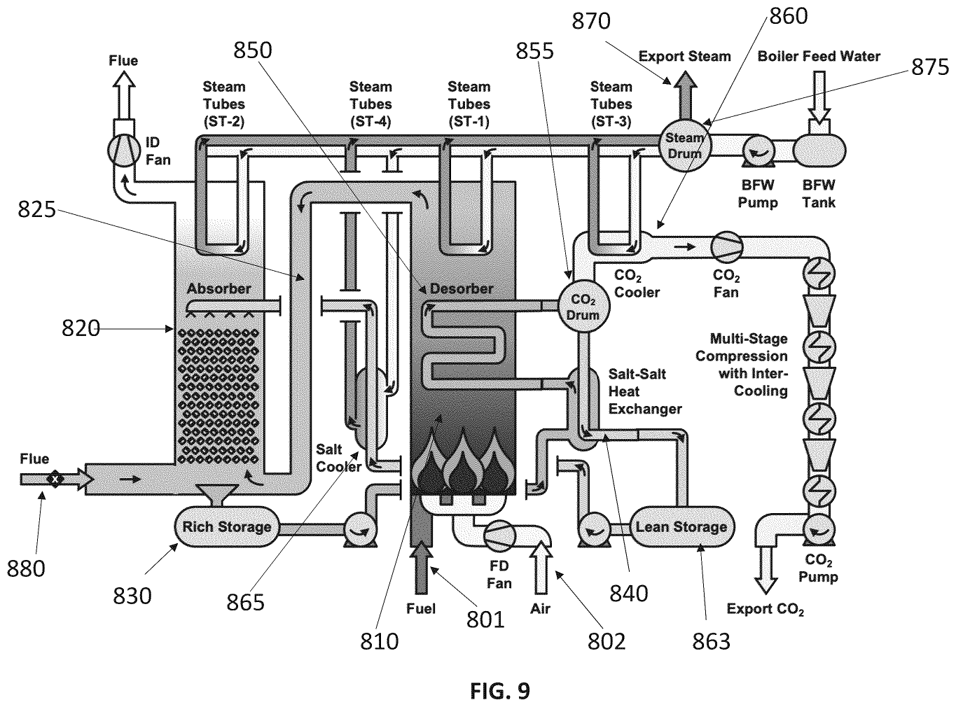

In some cases, CO₂ is captured from one or more additional flue sources (in addition to the CO₂ captured from the high temperature system located in or near the desorber). For example, FIG. 9 shows the system of FIG. 8 with an additional CO₂ source (880). The additional CO₂ source can be an existing flue. CO₂ from the additional CO₂ source (880) can be fed to the absorber (820). The CO₂ from the additional CO₂ source (880) can be combined with the CO₂ from the high temperature system at absorber (820). The additional CO₂ source (880) can be an existing system. The system shown in FIG. 8 can be retrofitted on to the existing system to capture CO₂ and mitigate CO₂ emissions of the existing system, thereby achieving the design shown in FIG. 9.

### Example 8: CO₂ Capture from Flue Source External to High Temperature System

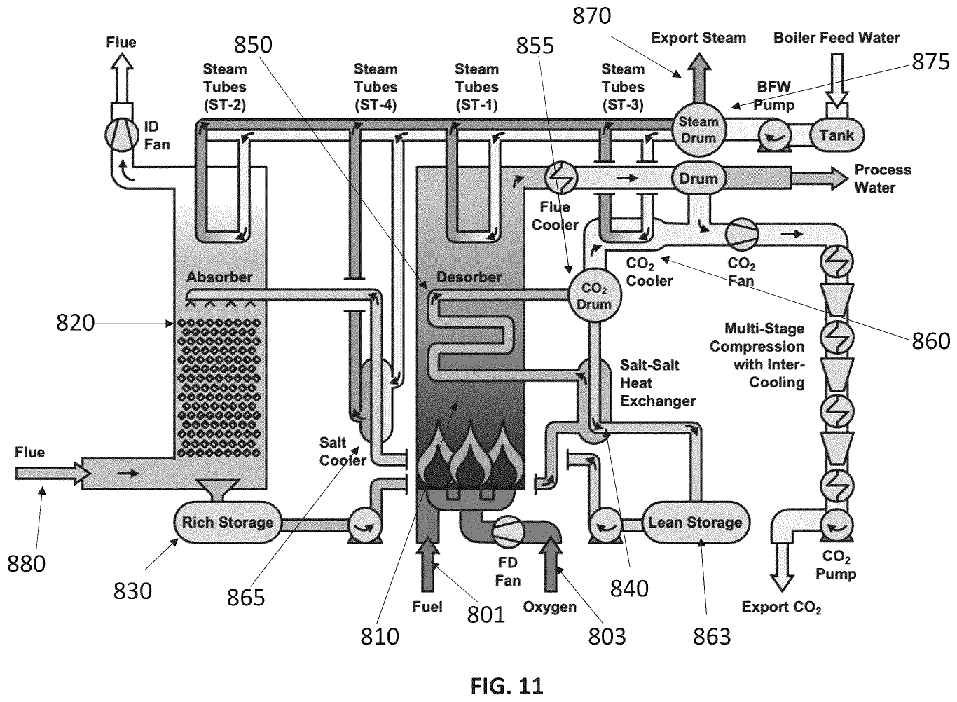

A process for capturing carbon dioxide from a flue (880) is illustrated in FIG. 11. A flue source (880) may contain carbon dioxide (CO₂) as a byproduct of an industrial process. The flue, containing CO₂, can be directed to an absorber (820). In some cases, a molten borate salt enters the absorber from the top, trickles down the packed bed where it contacts and captures at least a portion of the CO₂, thereby obtaining a CO₂-rich molten salt stream. The CO₂-rich molten salt stream may collect at the bottom of the absorber. Heat generated in the absorber may be transferred to piping or tubing with liquid water and can be used to heat liquid water to gaseous steam in steam tubes (ST-2). The CO₂-rich molten salt stream may be stored for a period of time in rich storage tank (830). The CO₂-rich molten salt stream may be directed to a salt-salt heat exchanger (840) using one or more pumps. After exiting the salt-salt heat exchanger (840), the CO₂-rich molten salt stream may be directed to a desorber (850). The desorber (850) may be located entirely or partially within a high temperature system (810). The high temperature system (810) may be a chamber of a boiler where fuel is burned (i.e., a firebox). A fuel (801) may enter the high temperature system and combust when contacted with oxygen (803), thereby producing CO₂ and water vapor. The oxygen source may be at least 90%, 95%, 96%, 97%, 98%, 99%, or 99.5% oxygen. The CO₂ produced in the high temperature system can be cooled, pressurized, and exported. Heat generated in the high temperature system may be transferred to piping or tubing with liquid water and can be used to heat liquid water to gaseous steam in steam tubes (ST-1). Alternatively, another heat fluid may be used. The heat generated from the high temperature system (i.e., boiler), may facilitate desorption of CO₂ from the molten salt. The desorber (850) may be a series of pipes or tubes located within the high temperature system (810). The desorber (850) may be in a coiled configuration. Alternatively, the desorber could be in a tube-in-tube or packed bed configuration. In the desorber (850), CO₂ can be desorbed from the molten salt, thereby resulting in a CO₂-lean molten salt stream and a CO₂ stream. A CO₂ drum (855) may be used to separate the CO₂ stream and the CO₂-lean molten salt stream. The CO₂ may be cooled using a CO₂ cooler (860). The CO₂ cooler (860) may include a stream of liquid water, which is used to cool the CO₂. At the CO₂ cooler, the CO₂ may heat the water. The liquid water may be heated such that it exits the CO₂ cooler as gaseous steam in steam tubes (ST-3). After exiting the CO₂ cooler (860), the CO₂ may be processed for export. The CO₂ may enter a multi-stage compression system with inter-cooling. The CO₂ can be transported and used off-site or stored (see FIG. 10). In some cases, the captured CO₂ is stored underground.

The CO₂-lean molten salt stream may exit the CO₂ drum (855) and be directed to the salt-salt heat exchanger (840). The salt-salt heat exchanger (840) can facilitate heat transfer from the CO₂-lean molten salt stream to the CO₂-rich molten salt stream, thus heating the CO₂-rich molten salt stream prior to entering the desorber (850). After exiting the salt-salt heat exchanger (840), the CO₂-lean molten salt stream may be stored for a period of time in lean storage tank (863). The CO₂-lean molten salt stream can be directed to a salt cooler (865). The salt cooler (865) can be used to transfer heat from the CO₂-lean molten salt stream to another fluid. In some cases, heat transferred from the CO₂-lean molten salt stream at the salt cooler (865) can be recovered. In some cases, heat transferred from the CO₂-lean molten salt stream at the salt cooler (865) can be used to preheat air. In some cases, heat transferred from the CO₂-lean molten salt stream at the salt cooler (865) can be used to heat water. Liquid water may be heated such that it exits the salt cooler as gaseous steam in steam tubes (ST-4). The CO₂-lean molten salt stream may then exit the salt cooler (865) and enter the absorber (820) to capture additional CO₂. Steam produced at any point in the system can exit the system as export steam. Steam from steam tubes ST-1, ST-2, ST-3, and ST-4 may be combined and exit the system through one export stream (870). Prior to exiting the system, steam may pass through a steam drum (875). Export stream (870) may be fed to a steam turbine, which can be used to convert thermal energy in the steam to electricity (see FIG. 10). Steam tubes ST-1, ST-2, ST-3, and ST-4 may be fluidically connected to a single water source or multiple water sources. Water may be pumped from a single source (i.e., a water tank) and partially diverted at various points in the system. A first portion of water may be diverted to the CO₂ cooler (860), where it is heated into steam, which flows through steam tubes ST-3. A second portion of water may be diverted to recover heat from the high temperature system, where it is heated into steam, which flows through steam tubes ST-1. A third portion of water may be diverted to the salt cooler (865), where it is heated into steam, which flows through steam tubes ST-3. A fourth portion of water may be diverted to recover heat from the absorber, where it is heated into steam, which flows through steam tubes ST-2.

### Example 9: Desorption Via Direct Spraying of CO₂-Rich Molten Salt

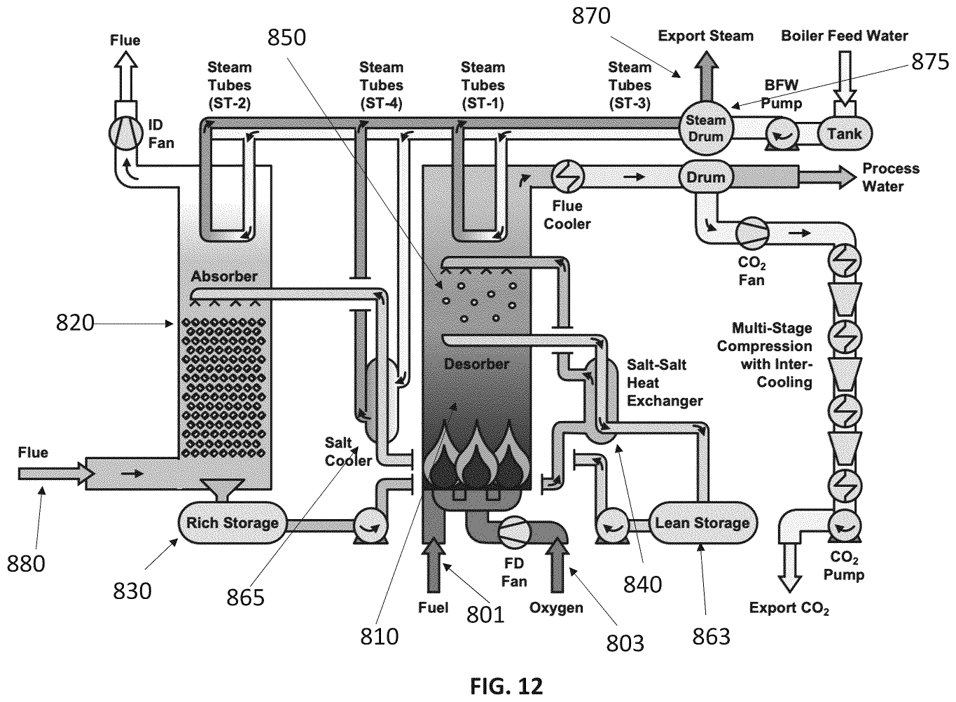

In some cases, the system shown in FIG. 11 can be modified such that in the desorber (850), the CO₂-rich molten salt stream is sprayed directly into the high temperature system (810). This configuration is shown in FIG. 12. The CO₂ can be desorbed from the molten salt, thereby resulting in desorbed CO₂ and a CO₂-lean molten salt stream. The CO₂-lean molten salt stream can exit the desorber (850) and be directed to the salt-salt heat exchanger (840). As such, the desorbed CO₂ and the CO₂ produced in the high temperature system via combustion of fuel and oxygen can be combined. The combined CO₂ can be cooled, pressurized, and exported.

### Example 10: Electrical Heating of Desorber

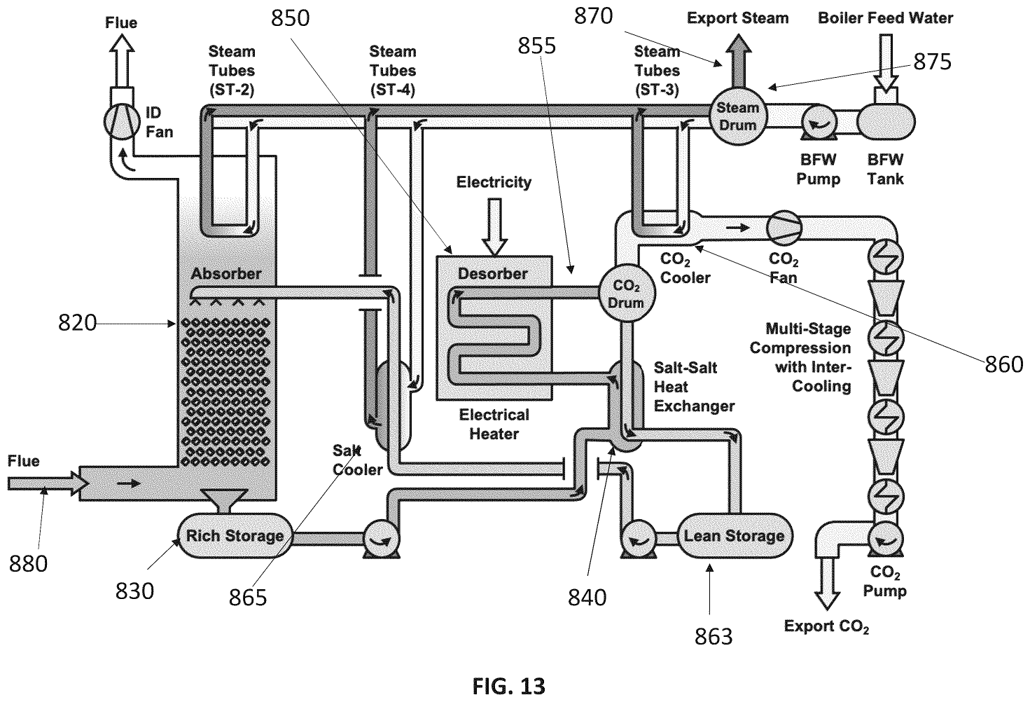

In some cases, the systems described herein can be modified such that the desorber is heated using electricity. Electrical heating can provide additional heating to facilitate desorption of CO₂ from the molten salt in the desorber. In some cases, as shown in FIG. 13, electrical heating can entirely replace the need for a high temperature system. FIG. 13 shows the system of FIG. 12 modified such that the desorber is heated entirely using electricity.

While certain embodiments of the present systems and methods have been shown and described herein, it will be obvious to those skilled in the art that such embodiments are provided by way of example only. It is not intended that the systems and methods described herein be limited by the specific examples provided within the specification. The descriptions and illustrations of the embodiments herein are not meant to be construed in a limiting sense. Numerous variations, changes, and substitutions will now occur to those skilled in the art without departing from the systems and methods described herein. Furthermore, it shall be understood that all aspects of the systems and methods described herein are not limited to the specific depictions, configurations or relative proportions set forth herein which depend upon a variety of conditions and variables. It should be understood that various alternatives to the embodiments described herein may be employed. It is therefore contemplated that the systems and methods described herein shall also cover any such alternatives, modifications, variations or equivalents. It is intended that the following claims define the scope of the systems and methods described herein and that methods and structures within the scope of these claims and their equivalents be covered thereby.

1. A method for capturing carbon dioxide (CO₂) from an industrial process, comprising:
(a) providing a gaseous stream comprising CO₂;
(b) contacting said gaseous stream with a first stream comprising a molten salt at an absorber, thereby absorbing CO₂ from said gaseous stream into said first stream to produce a second stream comprising said molten salt and said absorbed CO₂;
(c) directing said second stream to a desorber; and
(d) using said desorber, desorbing said absorbed CO₂ from said second stream, thereby generating (i) a third stream comprising said molten salt and (ii) an export stream comprising CO₂ desorbed from said second stream, wherein said third stream comprises less than 50 mol % steam.

2.-6. (canceled)

7. The method of claim 1, wherein a temperature of at least a portion of said industrial process exceeds a temperature of 600° C.

8.-14. (canceled)

15. The method of claim 1, wherein at least a portion of said industrial process comprises burning a solid fuel.

16. (canceled)

17. The method of claim 1, wherein at least a portion of said industrial process comprises burning a gaseous fuel.

18. (canceled)

19. The method of claim 1, wherein at least a portion of said industrial process comprises generating electricity, steam, heat, cement, steel, hydrogen, pulp, or paper, or any combination thereof.

20. The method of claim 1, wherein at least a portion of said industrial process occurs in a boiler, and wherein said boiler comprises a radiant section and a convection section.

21. (canceled)

22. The method of claim 20, wherein said radiant section exceeds a temperature of 600° C.

23. (canceled)

24. (canceled)

25. The method of claim 20, wherein said convection section exceeds a temperature of 200° C.

26. (canceled)

27. (canceled)

28. The method of claim 1, wherein said desorber is at a higher temperature than said absorber.

29. The method of claim 20, wherein said absorber is located in or adjacent to said convection section, and wherein said desorber is located in or adjacent to said radiant section.

30.-43. (canceled)

44. The method of claim 1, wherein said export stream has a CO₂ concentration of greater than 80%.

45.-52. (canceled)

53. The method of claim 1, further comprising, prior to (c), directing said second stream to a heat exchanger.

54. The method of claim 53, further comprising, subsequent to (d), directing said third stream to said heat exchanger.

55. The method of claim 54, wherein said heat exchanger facilitates heat transfer from said third stream to said second stream.

56.-58. (canceled)

59. The method of claim 1, wherein said first stream comprises at least a portion of the third stream.

60.-77. (canceled)

78. The method of claim 1, wherein the first stream, second stream, or third stream comprises a molten borate.

79. The method of claim 78, wherein said molten borate has a chemical form of AₓB₁₋ₓO_{1.5-x}, wherein x is a number between 0 and 1, and wherein A comprises an alkali metal.

80.-87. (canceled)

88. The method of claim 1, wherein said desorber is connected to said industrial process.

89. (canceled)

90. The method of claim 1, wherein said third stream comprises less than 20 mol % steam.

91.-93. (canceled)

94. The method of claim 1, wherein said gaseous stream comprising CO₂ is generated from said industrial process.

95.-98. (canceled)
